(19) United States
(12) Patent Application Publication
(10) Pub. No.: US 2007/0010700 A1
(43) Pub. Date: Jan. 11, 2007

(54) Safety containers for biologically active substances and method for producing said container

(75) Inventors: Hubert Bensmann, Halle/Westfalen (DE); Heiko Kranzmann, Bielefeld (DE); Eckhard Milsmann, Bielefeld (DE); Burkhard Wichert, Bielefeld (DE)

Correspondence Address: SENNIGER POWERS, ONE METROPOLITAN SQUARE, 16TH FLOOR, ST LOUIS, MO, 63102, US

(73) Assignee: Baxter International Inc, Deerfield, IL (US)

(21) Appl. No.: 10/541,692

(22) PCT Filed: Jan. 9, 2004
(86) PCT No.: PCT/EP04/00098

§ 371 Date: Aug. 29, 2006

(30) Foreign Application Priority Data
Jan. 9, 2003 (US) 60438822
Jan. 9, 2001 (DE) 103003231

(51) Int. Cl. G21F 9/00

(52) U.S. Cl. 588/1

(57) ABSTRACT

The invention relates to safety containers for biologically active substances, in particular cytostatic agents, said container having increased or higher fracture strength and shatterproof qualities, in addition to an uncontaminated exterior. The invention also relates to a method for producing said containers and to the use of a medium containing at least one polymer for decontaminating the exterior of a container that is filled with a biologically active substance, sealed and optionally labelled.

### FIELD OF THE INVENTION

The invention relates to safety containers for biologically active substances, in particular cytotoxic substances, having increased or high fracture strength and shatterproof strength, and a contamination-free outer surface, a process for its or their production, and the use of a medium which contains at least one polymer for the decontamination of the outer surface of a container which is filled with a biologically active substance, sealed and optionally labeled.

### PRIOR ART

Biologically active substances are used every day in all areas of life. In particular, the use of medicaments in human and veterinary medicine or of plant protection active compounds, such as herbicides, fungicides and insecticides, in plant protection can be mentioned here. The fields of use of biologically active substances in human and veterinary medicine are, for example, the therapy of diseases, such as, for example, the chemotherapy of tumors by the administration of cytostatics, the diagnosis of diseases and hereditary factors (for example as a substrate for enzyme reactions), analysis (for example as comparison substances) and genetic engineering (for example for the selection of cell lines).

Customarily, commercial ready-to-use packaging units, filled with a defined amount of the corresponding biologically active substance or substances, offered.

A large number of cytostatics must be administered to the patient by injection or infusion. In the preparation and carrying out of such administrations, numerous people, such as pharmacists, doctors, nurses and care personnel, are involved in inpatient treatment in hospital or outpatient treatment in specialized medical practices.

In this connection, it is absolutely to be avoided that the group of people treating the patient comes into contact with the cytotoxic substance, or another biologically active substance. Potential absorption, for example by touching with the skin, inhaling or swallowing, is to be feared, for example, if the container containing the biologically active substance shatters and the biologically active substance is thereby released into the environment in an uncontrolled manner. The same applies to the case in which traces of the cytostatic should still adhere to the outside of the container filled with the biologically active substance (e.g. cytostatic). The result would be that the personnel treating the patient would be exposed to endangerment of health and a risk of illness merely owing to contact with the container, e.g. by absorption via the skin, the airways or the gastrointestinal tract. In principle, even a single contact, all the more, of course, constant uncontrolled contact, with biologically active substances, is to be avoided.

On the part of the pharmaceutical industry, to this end care is to be taken that after the packaging process no traces of the biologically active substance, for example the cytotoxic substance, any longer adhere to the outer surface of the container or that they are present only in an inactive form which no longer contaminates the environment.

For this purpose, in practice treatment of the packaging unit, e.g. the vial containing the biologically active substance, such as, for example, a cytotoxic substance, is carried out using a washing medium, preferably a wash solution. However, after the washing process traces in the order of magnitude of a few ng of the biologically active substance per vial can still be detected. A customary threshold value is, for example, <1 μg per vial.

In order to contamination of the people coming into contact with the container, e.g. pharmacists and medical personnel, in the prior art, on the one hand, the wrapping of the packaging units with a sleeve or clear cylindrical shrink-wrap film of plastic has been proposed. The disadvantage of this process is that the packaging unit or the container is covered by the sleeve only on the sides and not on the bottom. It is further disadvantageous that for production the process has to be carried out at temperatures above room temperature. This can result in an adverse effect on the purity, storability, activity and the optical appearance of temperature-sensitive substances. It is also disadvantageous that for different dimensions (height, width, depth) and shapes of the packaging unit a special sleeve has to be tailored. This makes production time- and cost-intensive.

As a practical example of the use of a sleeve, the preparation doxorubicin from Faulding Asta Medica may be mentioned.

The second solution to the problem described in the prior art consists in the covering of the packaging unit with a second packaging, for example of plastic. The disadvantage here is that, depending on the size of the packaging unit, a fitting “overpackaging” has to be made. Moreover, the overall packaging is very voluminous and bulky. The handleability is also complicated: The people handling the packaging unit (e.g. pharmacists, doctors, care personnel) must first open the overpackaging in order even to reach the closure of the packaging unit at all. Furthermore, the opening process is an additional source of danger for the protective equipment (e.g. tear-sensitive gloves) of the handling people.

As a practical example of the use of a plastic surrounding packaging, the OncoSafe® from Hexal, which, for example, with the product cisplatin, may be mentioned.

Moreover, containers which are filled with a biologically active substance must have a high fracture strength and shatterproof strength.

The fracture strength of the container containing the biologically active substance depends, on the one hand, on the material of the container. Customarily, containers made of plastic have an increased fracture safety compared to containers made of glass. However, compared to glass, plastic has the disadvantage that it ages more rapidly (material fatigue), that it can enter into chemical and/or physical reactions with the biologically active or other ingredients or contaminates these (e.g. by the release of plasticizers from the plastic) and that certain plastics, in contrast to glass, can only be molded to give the desired molded articles with difficulty.

The shatterproof strength depends, for example, on the elasticity and the brittleness of the material of the molded article or container. Customarily, containers made of plastic have an increased shatterproof strength compared to containers made of glass. On account of the higher elasticity, plastic absorbs more impact or collision energy.

The fracture strength and shatterproof strength must furthermore also be granted during the transport of the containers, customarily in a relatively large pack. In this connection, on the one hand contact between safety containers and packaging agent (for example a carton or plastic material, e.g. Styropor®) and on the other hand contact of the safety containers with one another can occur. Preferably, in at least in one of the two cases there should be an increased fracture strength and shatterproof strength so that an appropriately suitable packaging can be tailored. A fracture strength and shatterproof strength in the case of contact of the safety containers with one another is particularly preferred, since then a simpler and thereby more inexpensive and space-saving packaging can be chosen.

There is consequently a need for a safety container for biologically active substances which is simple to produce and has an increased or high fracture strength and shatterproof strength and a contamination-free or contamination-minimized or contamination-reduced outer surface.

### SUMMARY OF THE INVENTION

Surprisingly, it has now been found that safety containers for biologically active substances having increased or high fracture strength and shatterproof strength, and a contamination-free outer surface can be obtained by completely or partly applying a coating by treating with a medium which contains at least one polymer to the outer surface of the filled, sealed and optionally labeled container.

The term “completely or partly” is in this connection thus to be understood as meaning that preferably all container areas of relevance for stability or contamination are coated. For example, for technical reasons an only partial coating of the container (e.g. the glass vial) could be carried out, the uppermost neck region of the container, for example, remaining uncoated. This is unproblematical if this part of the container never bursts and it likewise does not include the holding area, such that contamination of the container possibly remaining in this uncoated region has no consequences.

The person skilled in the art can take the decision whether coating has to be carried out completely or partially based on the present disclosure of the invention and the circumstances optionally further added (e.g. the degree of toxicity of the substance to be filled) in the course of his routine activity. According to one aspect of the present invention, a filled, sealed and optionally labeled safety container for biologically active substances having increased or high fracture strength and shatterproof strength, and a contamination-free outer surface, the container having a hollow body having at least one opening, one closure each per opening, optionally a label, and at least one biologically active substance filled into the hollow body is made available, characterized in that a coating has been applied completely or partially to the filled, sealed and optionally labeled container.

According to one embodiment of the present invention, a safety container is made available which has been provided with a label before the attachment of the coating.

According to a further embodiment of the present invention, a safety container is made available which has been treated with a wash medium before the attachment of the coating to the filled, sealed and optionally labeled containers.

According to a further embodiment a safety container according to one of the above aspects and embodiments is made available, characterized in that the coating is carried out at room temperature.

The safety container according to the invention is therefore particularly suitable as a packaging container for temperature-sensitive biologically active substances.

According to a further embodiment, a safety container according to one of the above aspects and embodiments is made available, characterized in that the coating has been attached to the container completely or almost completely.

According to a further embodiment, a safety container according to one of the above aspects and embodiments is made available, characterized in that the container is manufactured from glass, plastic or glass coated with plastic on the inside or outside.

Suitable kinds of glass are, for example, the glass types I-III. Glass type I can be used, for example, in the case of liquid products and glass type III, for example, for solids. The composition of the glass types is described in the USP and EP (USP 26-2003; chapter 661 Containers; pages 2142-2145//EP 4th edition: basic work 2002; chapter 3.2 Behältnisse [Containers]; pages 331-335).

Suitable plastics are, for example, polyethylene, polypropylene, polyvinyl chloride and Topas® (cyclo-olefin copolymer, Ticona). be. The requirements for plastic containers are described in the USP and EP (USP 26-2003; chapter 661 Containers; pages 2142-2143; 2145-2148//EP 4th edition: basic work 2002; chapter 3.2 Behaltnisse [Containers]; pages 331; 335-343).

According to a further embodiment, a safety container according to one of the above aspects and embodiments is provided, characterized in that it comprises at least one closure, for example, consisting of a rubber stopper and a crimped cap or of an alternative closure system.

Further suitable closure systems can be:

rubber stopper and Bioset®; rubber disk and crimped cap; closure systems from Becton & Dickinson, glass seals with or without an intended point of fracture.

According to a further embodiment, a safety container according to one of the above aspects and embodiments is made available, characterized in that the marking is a marking surface, preferably a written label of paper and/or plastic.

According to a further embodiment, a safety container according to one of the above aspects and embodiments is made available, characterized in that the biologically active substance has a liquid, solid or amorphous physical state at room temperature.

Suitable biologically active substances or materials can be, for example, the substances mentioned below (in alphabetical sequence according to the Rote Liste 2002):

abacavir, abciximab, acamprosate, acarbose, acebutolol, acecarbromal, aceclofenac, acemetacin, acetazolamide, acetylaminonitropropoxybenzene, acetylcholine chloride, acetylcysteine, β-acetyldigoxin, acetylmethionine, acetylsalicylic acid, acetyltyrosine, aciclovir, acipimox, acitretin, pimpernel, field forget-me-not, aconitine, acriflavinium chloride, actinoquinol, adapalene, ademethionine, adenosine, pheasant's-eye, adrenalone, malic acid, escin, esculin, agalsidase alpha, agalsidase beta, ajmaline, acacia, false, alanine, elecampane, alanylglutamine, albendazole, alclometasone, alcuronium chloride, aldesleukin, aldioxa, alemtuzumab, alendronic acid, alphacalcidol, alphatradiol, alfentanil, alfuzosine, algeldrate, alginic acid, alimemazine, alizapride, alkyldimethyl-ethylbenzylammonium chloride, alkyloligoamine, allantoin, allergen extracts, allethrin 1, allopurinol, allyl mustard oil, almasilate, almotriptan, aloe, cyclamen, alpha-1 proteinase inhibitor, alprazolam, alprostadil, autumn mandrake, alteplase, aluminum acetate, basic, aluminum acetate tartrate, aluminum chloride, aluminum chloride hydroxide complex, aluminum formate, aluminum glycinate dihydroxide, aluminum hydroxide, aluminum hydroxide distearate, aluminum hydroxide gel, aluminium hydroxychloride, aluminum magnesium silicate hydrate, aluminum magnesium silicopolyhydrate, aluminum monostearate, aluminum sodium carbonate dihydroxide, aluminum sodium silicate, aluminum oxide, aluminium oxychloride, aluminum phosphate, aluminum silicate, aluminum sulfate, amantadine, ambra, ambroxole, amcinonide, ant, formic acid, amezinium metilsulfate, amfepramon, amfetaminil, amidotrizoic acid, amifostin, amikacin, amilomer, amiloride, aminoalkylglycine, aminobenzoic acid, aminoglutethimide, aminomethylbenzoic acid, aminophylline, aminoquinuride, amino acids, aminosalicylic acid, amiodarone, amisulpride, amitriptyline, amitriptyline oxide, amlodipine, ammonia liquid, anisole-containing, ammonium, ammonium bituminosulfonate, ammonium bituminosulfonate, light, ammonium bromide, ammonium carbonate, ammonium chloride, ammonium dodecylsulfate, ammonium iron sulfate, ammonium molybdate, ammonium monohydrogencitrate, ammonium phosphate, amnion, amorolfin, amoxicillin, amoxicilin+clavulanic acid, amphotericin B, ampicillin, amprenavir, amrinone, amsacrine, amylase, pineapple, anastrozole, horehound, white, anethole, anetholetrithione, angelica, angurate, angustura, aniseed, anistreplase, antazoline, antimony, metallic, antimony pentasulfide, antimony trisulfide, antithrombin III, apple, apomorphine, apraclonidine, aprotinin, arginine, arginine aspartate, argipressin, arnica, arsenic iodide, arsenic trioxide, artemether, artery, articaine, artichoke, ascorbic acid, asparagine, asparaginase, aspartic acid, Aspergillus, atenolol, atorvastatin, atosiban, atovaquone, atracurium besilate, atropine, auranofin, avocado oil, azapropazone, azathioprine, azelaic acid, azelastine, azidamfenicol, azidocillin, azithromycin, azosemide, aztreonam,

bacampicillin, Bacillus cereus, Bacillus firmus, Bacillus IP 5832, Bacillus subtilis, bacitracin, baclofen, bearberry, club moss, wild garlic, bacterial autolyzate, valerian, valerian oil, balloon vine, balsam pear, bambuterol, bamethane, bamipine, intervertebral disk, barium acetate, barium carbonate, barium chloride, barium iodide, barium sulfate, beard lichen, basil, basiliximab, tree moss, agaric, becaplermine, beclomethasone, comfrey, bemetizide, benazepril, bencyclan, bendamustine, bendro-flumethiazide, holy thistle, benfotiamine, benperidol, benproperine, benserazide, benzalkonium chloride, benzbromarone, benzethonium chloride, benzocaine, benzoin, benzoic acid, benzoxonium chloride, benzoyl peroxide, benzyl alcohol, benzyl benzoate, benzyl mandelate, benzyl nicotinate, benzylpenicillin, benzylpenicillin-benzathine, benzylpenicillin-procaine, berberis, mountain laurel, succinic acid, broom, betacarotene, betahistine, betaine dihydrogencitrate, betaine hydrochloride, betamethasone, betaxolol, bethanechol, bezafibrate, beaver, burnet saxifrage, bibrocathol, bicalutamide, bee, bee venom, royal jelly, beeswax, Bifidum bacteria, bifonazole, biguanide, biotin, biperidene, 2-biphenylol, birch, bisacodyl, bismuth aluminate, bismuth carbonate, bismuth chloride oxide, bismuth(III) citrate hydroxide complex, bismuth gallate, basic, bismuth nitrate, basic, bismuth oxide (iodide-resorcinol complex), bismuth salicylate, basic, bisoprotol, bitterwood, buck bean, woody nightshade, bladderwrack, hydrocyanic acid, lead, lead acetate, lead plaster, bleomycin, blood, human blood clotting factor IX (freeze-dried), blood clotting factor VIII (CHO), human blood clotting factor VIII (freeze-dried), human blood clotting factor VII (freeze-dried), blood clotting factor X, blood clotting factor XIII, blood-root, Canadian, fenugreek, bean, boldo, bopindolol, bomaprine, borneol, bornyl acetate, bornyl salicylate, boric acid, bovist, figwort, nux vomica, tartar emetic, ipecac, great plantain, stinging nettle, spectacled cobra, brimonidine, brinzolamide, brivudine, brom-azepam, blackberry, bromocamphor, bromochlorophene, bromelaine, bromhexine, bromide ions, bromonitro-dioxacyclohexane, bromocriptine, bromperidol, bromo-salicylic acid, brotizolam, Brucella bacteria, rupture-wort, watercress, buchu, buckwheat, buclizine, budesonide, budipine, bufexamac, buflomedil, bufo, bumetanide, bunazosine, buphenine, bupivacaine, bupranolol, buprenorphine, bupropion, dwarf bean, bush clover, buserelin, buspirone, busulfan, butanediol, butinoline, butizide, butoxycaine, buttercup, butylhydroxyanisole, butylscopolaminium bromide,

cabergoline, cactus, cadexomer iodine, cafedrine, cajuput oil, calcifediol, calcipotriol, calcitonin, calcitriol, calcium acetate, calcium aminoethyl-phosphate, calcium aspartate, calcium bromide, calcium carbonate, calcium carbonate Hahnemanni, calcium chloride, calcium citrate, calcium dobesilate, calcium fluoride, calcium folinate, calcium glucoheptonate, calcium gluconate, calcium hydrogenphosphate, calcium iodide, calcium lactate, calcium lactobionate, calcium lactogluconate, calcium magnesium inositol hexa-phosphate, calcium pantothenate, calcium phosphate, calcium phosphinate, calcium phospholactate, calcium sucrate, calcium salts, calcium silicate, calcium sulfate, calcium trisodium pentetate, camphene, camphor, camphor oil, camphor oil, strong, candesartan, Candida, capecitabin, capsaicin, captopril, carazolol, carbachol, carbamazepine, carbamoylphenoxyacetic acid, carbazochrome, carbidopa, carbimazole, carbinoxamine, carbocysteine, carbomer, carboplatin, cardiospermum, carisoprodol, carmellose, carmustine, carotene, carrageenan, carteolol, carvediol, cascara, catalase, Causticum Hahnemanni, cayenne pepper, cefaclor, cefadroxil, cefalexin, cefazoline, cefepime, cefetamet cefixime, cefotaxime, cefotiam, cefoxitine, cefpodoxime, ceftazidime, ceftibutene, ceftriaxone, cefuroxime, celecoxib, celiprolol, cellaburate, cellulose polysulfuric acid ester, cerium chloride, certoparine, ceruletide, C1-esterase inhibitor, cetirizine, cetrimonium bromide, cetrorelix, cetyl alcohol, cetyl palmitate, cetylpyridinium chloride, cetylstearyl alcohol, cetylstearyl octanoate, chenodeoxycholic acid, cinchona bark, quinidine, quinine, 3-quinolinol sulfate, chirata, chloral hydrate, chlorambucil, chloramphenicol, chlor-diazepoxide, chloracetic acid, chloroethane, chlorhexidine, chloride, chlormadinone, chlorobutanol, chlorocresol, chlorophylline, chlorophylline copper complex, chloroquine, chloroxylenol, chlorphenamine, chlorphenesin, chlorphenoxamine, chlorpromazine, chlorprothixene, chlorquinaldol, chlorthalidone, chlorotetracycline, chlortheophylline, cholera vibriones, cholesterol, choline chloride, choline citrate, choline hydrogentartrate, choline salicylate, choline stearate, choline theophyllinate, chondroitin-sulfuric acid, choriongonadotrophin, choriongonado-tropin alpha, Christmas rose, chromium, chrome alum, chromium hydrogenaspartate, chymotrypsin, cicletanine, ciclopirox, ciclosporin, ciclofovir, cilastatin, cilazapril, cimetidine, Cimicifuga, Cina, cinchocaine, cinchonine, cineol, cinnarizine, cinoxacin, ciprofloxacin, cisatracurium besilate, cisplatin, citalopram, citronenic acid, L-(+)-citrulline, cladribine, clarithromycin, clavulanic acid, clemastine, clemizole-penicillin, clenbuterol, clindamycin, clioquinol, clobazam, clobetasol, clobetasone, clobutinol, clocortolone, clodronic acid, clomethiazole, clomifen, clomipramine, clonazepam, clonidine, clopamide, clopidogrel, cloprednol, clorofen, clostebol, Clostridium botulinum toxin type A, Clostridium botulinum toxin type B, Clostridium histolyticum collagenase, clotrimazole, clozapine, co-carboxylase, cochineal insect, cocoa butter, cocopropylenediamine guanidinium, cocopropylenediamine guaniacetate, codeine, codeine camphorsulfonate, codonopsis, coenzyme A, caffeine, colchicine, colecalciferol, colestipol, colestyramine, colfosceril palmitate, colistimethate sodium, colistine, Comocladia, Condurango, corticorelin, cortisone, co-trimoxazole, croconazole, cromoglycic acid, crotamiton, coumarin, curare, cyanocobalamin, cyclandelate, cyclopentolate, cyclophosphamide, cyproheptadine, cyproterone, cysteine, L-(−)-cystine, cytarabine, cytidine, cytidine phosphate,

dacarbazine, daclizumab, dactinomycin, dalfopristin, dalteparin sodium, damiana, danaparoid, danazole, dantrolene, dapiprazole, dapsone, darbepoetin alpha, intestine, daunorubicin, deanol, deanol orotate, dectaflur, decyl oleate, deferipron, deferoxamine, deflazacort, demelverine, denaverine, dequalinium salts, desfluran, desipramine, desirudin, deslanoside, desloratadine, desmeninol, desmopressin, desogestrel, desoxymetasone, deoxyribonuclease, detajmium bitartrate, dexamethasone, dexchlorpheniramine, dexibuprofen, dexketoprofen, dexpanthenol, dextran, dextranomer, dextromethorphan, dialkyldimethylammonium chloride, diazepam, diazoxide, dibenzepine, dibromohydroxybenzenesulfonic acid, dibutyl adipate, dichlorobenzyl alcohol, diclofenac, diclofenamide, dicloxacillin, didanosine, didecyldimethylammonium chloride, didecylmethylalkoxyammonium propionate, didecylmethyloxyethylammonium propionate, dienogest, diethylamine salicylate, diethylene glycol, diflorasone, diflucortolone, digitalin, digitalis antitoxin, digitoxin, digoxin, dihydralazine, dihydrocodeine, α-dihydroergocryptine, dehydro-ergotamine, dihydroergotoxin, dihydrotachysterol, dihydroxydioxahexane, diisopropylamine, dipotassium clorazepate, diltiazem, dimenhydrinate, dimercapto-propanesulfonic acid, dimethylaminophenol, dimethyl fumarate, dimethyl sulfoxide, dimethyltoluidine, dimethicone, dimetindene, disodium inosine-5′-monophosphate2H2O, dinoprost, dinoprostone, diosmin, dioxopromethazine, diphenhydramine, diphenylpyraline, diphtheria bacteria, dipivefrin, dipyridamol, disopyramide, distearyl hydrogencitrate, distigmine bromide, disulfiram, dithranol, dobutamine, docetaxel, docusate sodium, dodecylbenzenesulfonic acid, dodecylbispropylenetriamine, dolasetron, domperidone, donepezil, dopamine, dopexamine, dornase alpha, dorzolamide, dosulepine, doxapram, doxazosine, doxepine, doxorubicin, doxycycline, doxylamine, drofenine, dropropizine, drospirenone, dydrogesterone,

mountain ash, southernwood, carline thistle, econazole, Spanish chestnut, silver fir, edetic acid, efavirenz, ivy, speedwell, hibiscus, oak, eggshells, ovaries, herb Paris, single-grained wheat root, false, iron, iron ammonium citrate, green, iron aspartate, iron bromide, iron(II) chloride, iron(III) chloride, iron(II) fumarate, iron(II) gluconate, iron(III) gluconate, iron glycine sulfate, iron hexacyanoferrate, aconite, iron hydrogen aspartate, iron(III)-hydroxide-dextran complex, iron(III)-hydroxide-polymaltose complex, iron(III) hydroxide-sucrose complex, iron iodide, iron(III)-potassium citrate phosphate complex, verbena, iron sodium citrate, iron oxide, iron phosphate(III), iron, red, iron sucrose, iron sorbitol, iron succinate, iron sulfate, cashew nut, East Indian, Eleutherococcus root, embryo, emedastine, enalapril, enalaprilate, enfluran, enoxacin, enoxaparin, enoximon, entacapon, gentian, ephedra, ephedrine, Epigaea, epinephrine, epirubicin, epoetin alpha, epoetin beta, eprazinone, eprosartan, eptacog alpha, activated, eptifibatide, groundnut, common fumitory, ergocalciferol, ergotamine, erythromycin, ash, ash, white, Scotch thistle, esmolol, esomeprazole, aspen, American, Espeletia, acetic acid, estradiol, estradiol benzoate, estradiol valerate, estramustin, estriol, estrogens, conjugated, ethacrynic acid, etamivan, etanercept, ethacridine, ethambutol, ethanol, ethenzamide, ethers, Spiritus aethereus, ethinylestradiol, ethiodate oil, ethosuximide, ethyl cyanoacrylate, ethylhexanal, ethyl hydrogenfumarate, ethyl linolate, ethyl nicotinate, etidronic acid, etilefrine, etofenamate, etofibrate, etofylline, etofylline clofibrate, etomidate, etonogestrel, etoposide, eucalyptus, exemestan,

Fabian, famciclovir, famotidine, fango, alder buckthorn, febuprol, fig, felbamate, felbinac, felodipine, felypressin, fennel, fenchone, fendilin, fenetylline, fenipentol, fenofibrate, fenoterol, fentanyl, fenticonazole, ferucarbotran, ferumoxsil, fatty acids, essential, fexofenadine, human fibrinogen (freeze-dried), bovine fibrinolysin, spruce, pine needle oil, cinchona bark, filgrastim, finasteride, foxglove, purple, foxglove, Grecian, fish oil, flavoxate, flecainide, meat extract, fleroxacin, fly agaric, plantago seed, Indian, flucloxacillin, fluconazole, flucytosine, fludarabin phosphate, fludrocortisone, flufenamic acid, flumazenil, flumetasone, flunarizine, flunisolide, flunitrazepam, fluocinolone acetonide, fluocinonide, fluocortin butyl, fluocortolone, fluorine, fluorescein, fluorescein dilaurate, fluorite, fluorometholone, fluorouracil, fluoxetine, flupentixol, fluphenazine, flupirtin, fluprednidene, flurazepam, flurbiprofen, fluspirilene, river eel, hydrofluoric acid, freshwater sponge, flutamide, fluticasone, fluvastatin, fluvoxamine, folitropin alpha, folitropin beta, folic acid, fomiviruses, formaldehyde, formestan, formoterol, foscarnet sodium, fosfestrol, fosfomycin, fosinopril, framycetin, lady's-mantle, lady's-slipper, Friedlander's bacilli, amniotic fluid, fructose, FSME viruses, fumaric acid, furazolidone, furosemide, fusafungin, fusidic acid

gabapentin, gadobenic acid, gadobutrol, gadodiamide, gadopentetic acid, gadoteridol, daisy, goose grass, Gaffkya tetragena, sweet gale, galactose, galantamine, galingale, gallbladder, gelatinous core, gallopamil, Galphimia, ganciclovir, ganirelix, vessel, brain, gelatine, gelatine polysuccinate, yellow fever viruses, yellowroot, turmeric, Javan, turmeric, Canadian, joints, synovial membrane, synovial capsule, gelsemin, gemcitabine, gemeprost, gemfibrozil, gentamicin, geranium, tannins, gestodene, gestonorone caproate, clove, sweet-scented sumach, fringe tree, Atlantic poison oak, ginkgo, ginseng, vitreous humor, glibenclamide, glibomuride, gliclazide, glimepiride, gliquidone, Russian belladonna, glucagon, gluconic acid, glucoprotamine, glucosamine, glucose, glutamic acid, glutaral, glutathione, glycerol, glycerol dihydrogenphosphate, glycerol dihydrogenphosphate, magnesium salt, glycerol monostearate, glycerol oleate, glycerol palmitostearate, glycerol trinitrate, glycine, glycopyrronium bromide, glycylglutamine, glycyl-tyrosine, glyoxate, gneiss, tree of heaven, gold, gold chloride, gold iodide, golden ragwort, wallflower, laburnum, golden rod, golden rod, early, gold trichloride, yellow, gonadorelin, goserelin, hedge hyssop, gramicidin, pomegranate, granisetron, graphite, Grindelia, griseofulvin, guaifenesin, guaiacol, pockwood tree, guaiazulene, guanethidine, guanidine, guarana, guar flour, ground ivy, gypsophila saponin

hemagglutinin, hematoporphyrin, hemin, hemoglobin, Haemophilus influenzae, oats, buttercup , cohosh, blue, buttercup, bulbous, shark liver oil, halcinonide, halofantrin, halomethasone, haloperidol, halothane, Hamamelis, hemp, hemp, Canadian, bladder mucosa, 13C-urea, urea-hydrogen peroxide addition compound 1:1, Haronga, hard paraffin, hazelwort, restharrow, skin, yeast, blueberry, Heisteria, scullcap, Helveticus bacteria, heparin, heparinoids, hepatitis viruses, inactivated, heptaminol, meadow saffron, heart, motherwort, meadow grass flowers, hexacalcium hexasodium heptacitrate hexahydrate complex, hexachlorophene, hexadecyloctadecylisopropyl myristate, hexaurea aluminum chlorate, hexamidine, hexetidine, hexylresorcinol, cerebral membrane, cerebral cortex, millet, shepherd's purse, hirudine, histamine, histidine, histidine zinc 2H₂O, hemp nettle, elder, wood charcoal, powdered, wood tar, homatropine hydrobromide, honey, hops, hornet, sand viper, hydrangea, coltsfoot, human albumin, humic acids, dog milk, hyaluronidase, hyaluronic acid, hydralazine, hydrastine, hydrastinine, hydroquinone, hydro-chlorothiazide, hydrocodone, hydrocortisone, hydro-cortisone acetate, hydrocortisone buteprate, hydro-cortisone 17-butyrate, hydrocortisone hydrogen-succinate, hydrogencarbonate, hydromorphone, hydrotalcite, hydroxocobalamin, hydroxybenzoic acid, hydroxybutyric acid, hydroxycarbamide, hydroxyl-chloroquine, hydroxyethylcellulose, hydroxyethyl-rutoside, hydroxyethyl salicylate, hydroxyethylstarch, hydroxyprogesterone caproate, hydroxyzine, hyetellose, hymecromone, Hyoscyamus, pituitary gland, hypromellose

ibandronic acid, ibuprofen, icodextrin, idarubicin, idoxuridine, ifosfamide, Ignatia, iloprost, imidapril, imiglucerase, imipenem, imipramine, imiquimod, periwinkle, Canadian, periwinkle, lesser, immuno-globulin (botulism), immunoglobulin (cytomegalovirus), immunoglobulin (FSME), immunoglobulin G, rabbit, antihuman T-cell, immunoglobulin G, horse, antihuman T-cell, immunoglobulin (hepatitis B), immunoglobulin (human), immunoglobulin (IgA), immunoglobulin (IgG), immunoglobulin (IgM), immunoglobulin (tetanus), immunoglobulin (rabies), immunglobulin (varicella zoster), indanazoline, indapamide, indigo root, indinavir, indocyanine green, indomethacin, indoramine, infliximab, influenza viruses, ginger, inosine (dimepranol-4-acetamidobenzoate) 1:3, inositol, inositol nicotinate, insulin aminoquinuride (bovine), insulin aminoquinuride (porcine), insulin aspart, insulin glargine, insulin human, insulin human-isophan, biphasic, insulin human-zinc, mixed, insulin human-zinc, crystalline, insulin isophane, insulin lispro, insulin normal (bovine), insulin normal (porcine), insulin-zinc injection suspension, amorphous (porcine), interferon alpha-2a, interferon alpha-2b, interferon alpha-2b, liposomal (PEG), interferon alphacon-1, interferon beta, interferon beta-la, interferon beta-Ib, interferon gamma-1b, intrinsic factor, iobitridol, iodine, iodixanol, iodoform, iodine (trace element), iohexol, iomeprol, iopamidol, iopentol, iopromide, iosarcol, iothalamic acid, iotrolan, iotroxic acid, ioversol, ioxaglic acid, ioxithalamic acid, ipratropium bromide, iprazochome, irbesartan, irinotecan, isobornyl acetate, isoconazole, isofluran, isoleucine, isoniazide, isoprenaline, isopropyl myristate, isopropyl palmitate, isosorbide dinitrate, isosorbide mononitrate, isotretinoin, isradipine, itraconazole

jaborandi leaves, Jalape, jasmin, yellow, currant, European black, St-John's-wort, josamycin, josamycin propionate

coffee, coffee coal, potassium acetate, potassium adipate, potassium aminoethylphosphate, potassium bromide, potassium canrenoate, potassium carbonate, potassium chlorate, potassium chloride, potassium citrate, potassium dichromate, potassium dihydrogen-phosphate, potassium disulfite, potassium hydrogen-aspartate, potassium hydrogencarbonate, potassium hydrogenglutamate, potassium hydrogenoxopentanedioate, potassium hydroxide, potassium iodide, potassium monohydrogenphosphate, potassium sodium hydrogen-citrate, potassium phosphate, potassium salts, potassium sulfate, potassium tartrate, sulfurated lime, lime water, calamus, camomile, camomile oil, camomile, Roman, kanamycin, cantharidene, nasturtium, karaya gum, cardamoms, potato, cashew nut, cat thyme, kavain, kava root, gonads, male, keratin, kermes berry, ketamine, ketoconazole, ketoprofen, ketorolac tromethanol, ketotifen, pine, silica, purified, cherry laurel, rattlesnake, cerebellum, burdock, garlic, bone, bone marrow, cartilage, cobalt, cobalt chloride, cobalt hydrogen aspartate, cobalt sulfate, Indian berries, Aaron's rod (mullen flower), charcoal, medicinal, carbon dioxide, cola tree, Colibacteria, collagen, colocynth, conifer, copaiva balsam, coral, red, coriander, creosote, garden spider, cubeb pepper, cockroach, pasque flower, caraway, squash, copper, copper arsenite, copper(II) chloride, copper diacetate, copper gluconate, copper hydrogenaspartate, copper(II) sodium citrate, copper nitrate, copper oxide, copper sulfate

Yellow bedstraw, Lachesis, lacidipine, lactitol, lactose, lactulose, purging agaric, larch turpentine, lamivudine, lamotrigin, lansoprazole, Larrea mexicana, latanoprost, templin oil, laurylpropylenediamine, lavender, white cedar, liver, fish-liver oil, lecithin, leflunomide, flax, lenograstim, lepirudine, Leptandra, lercanidipine, yellow fumitory, letrozole, leucine, leukocyte ultrafiltrate, leuprorelin, levamisole, levetiracetam, levobunolol, levocabastine, levo-carnitine, levocetirizine, levodopa, levofloxacin, levoglutamide, levomenol, levomenthol, levomepromazine, levomethadone, levonorgestrel, levothyroxine, levo-thyroxine sodium, lidocaine, lovage, lincomycin, lindan, linden blossom, 9,12-linoleic acid, liothyronine, α-lipoic acid, (±)-α-lipoic acid, lisinopril, lisuride, lithium acetate, lithium benzoate, lithium carbonate, lithium chloratum, lithium chloride, lithium citrate, lithium salicylate, lithium salts, lithium succinate, lithium sulfate, lobelia, lodoxamide, scurvy grass, dandelion, lofepramine, lomefloxacin, lomustine, lonazolac, loperamide, lopinavir, loprazolam, loracarbef, loratadine, lorazepam, lormetazepam, lornoxicam, losartan, lovastatin, Luesinum, sponge loofah, lumefantrin, lung, lungwort, lutropin alpha, lymph nodes, lynestrenol, lysine, DL-lysine mono(acetylsalicylate), lysozyme

macrogol, macrogol cetylstearyl ether, macrogol glycerolstearate, macrogol lauryl ether, macrogol polyoxypropylenedodecyl tetradecyl ether, mudar, meadowsweet, butcher's broom, magaldrate, stomach, magnesium acetate, magnesium adipate, magnesium aminoethylphosphate, magnesium aspartate, magnesium aspartate hydrobromide, magnesium aspartate hydrochloride, magnesium carbonate, magnesium chloride, magnesium citrate, magnesium fluoride, magnesium gluconate, maqnesium hydrogenaspartate, magnesium hydrogencitrate, magnesium hydrogenglutamate, magnesium hydrogenphosphate, magnesium hydroxide, magnesium monoperoxyphthalate magnesium nicotinate, magnesium oxide, light, magnesium oxide, heavy, magnesium peroxide, magnesium phosphoricum (hom.), magnesium pyridoxalphosphate glutamate, magnesium salts, magnesium sulfate, magnesium trisilicate, mahonia, lily of the valley, corn, corn smut, marjoram, Malabar nut, mangafodipir, manganese chloride, manganese digluconate, manganese dioxide, manganese hydrogenaspartate, manganese sulfate, manna, mannitol, maprotilin, milk thistle, measles viruses, mate, stonecrop, mebendazole, mebeverine, mecetronium ethylsulfate, meclocycline, meclofenoxate, meclozine, medazepam, Medorrhinum, medrogestone, medroxy-progesterone, horseradish, sea salt, bath sponge, sea water, sea onion, mefenamic acid, mefloquine, mefruside, megestrol acetate, masterwort, melissa, pawpaw tree, meloxicam, melperone, melphalan, memantine, menadiol, meningococci polysaccharide vaccine, meniscus, menotropin, menthone, mephenesin, mepindolol, mepivacaine, meprobamate, meptazinol, mequitazine, merbromine, mercaptamine, mercaptopurine, meropenem, mesalazine, mesna, mesterolone, mestranol, mesulfen, mesuximide, meta-silicic acid, metamfepramon, metamizole, metenolone, metergoline, metformin, methacholine chloride, methanol, methanthelinium bromide, methenamine, methenamine hippurate, methenamine-silver nitrate 1:2, methionine, methocarbamol, methohexital, methotrexate, methoxsalene, methyldopa, methylergometrine, methyl hydroxybenzoate, methyl nicotinate, methyloxobutyric acid, methyloxovaleric acid (3), methyl oxovaleric acid (4), methylphenidate, methylprednisolone, methylrosalinium chloride, methyl salicylate, methylthioninium chloride, methysergide, metildigoxin, metipranolol, metixene, metoclopramide, metolazone, metoprolol, metronidazole, mexiletine, mezlocillin, mianserin, miconazole, midazolam, midodrin, miglitol, microwax, powdered milk, lactic acid, Lactobacterium acidophilum, milrinone, miltefosine, spleen, mineral salts, synthetic, mineral salts, natural, minocycline, minoxidil, mint oil, mirtazapine, misoprostol, mistletoe, mitomycin, mitoxantrone, mivacurium chloride, mizolastine, moclobemide, modafinil, monk's pepper, moexipril, mofebutazone, poppy, Californian, molgramostime, molsidomine, molybdenum, mometasone furoate 1H2O, montelukast, peat, moss, Irish, moss, Icelandic, Moraxella lacunata, moroctocog alpha, morphine, musk, moxaverine, moxifloxacin, moxonidine, mucin, Mucor mucedo, Mucor racemosus, money-wort, mumps viruses, mupirocin, marmot, muromonab-CD3, nutmeg, muscle, ergot, Mycobacterium phlei, mycophenolate mofetil, myrrh, myrtecaine, Myrtillocactus, myrtol

N-(2-hydroxyethyl)-10-undecenamide, umbilical cord, evening primrose, black nightshade, nadid, nadolol, nadroparin calcium, nafarelin, naftidrofuryl, naftifin, nalbuphine, naloxone, naltrexone, nandrolone, naphazoline, naproxen, naratriptan, spikenard, American, nasal mucosa, natamycin, nateglinide, sodium acetate, sodium alginate, sodium aminoethylphosphate, sodium aurothiomalate, sodium benzoate, sodium bituminosulfonate, light, sodium bituminosulfonate, dry matter, sodium bromide, sodium carbonate, sodium chloride, sodium chlorite, sodium citrate, sodium dibunate, sodium dihydrogenphosphate, sodium fluoride, sodium fluorophosphate, sodium gluconate, sodium hydrogencarbonate, sodium hydrogenglutamate, sodium hydroxide, sodium hypochlorite, sodium iodide, sodium lactate, sodium laurylsulfoacetate, sodium molybdate, sodium monohydrogencitrate, sodium monohydrogen-phosphate, sodium nitrate, sodium oxalacetate, sodium pantothenate, sodium pentosan polysulfafe, sodium perborate, sodium perchlorate, sodium peroxide, sodium phenylbutyrate, sodium phosphate, sodium picosulfate, sodium salicylate, sodium salts, sodium selenite, sodium sulfate, sodium tetraborate, sodium tetra-chloroauratum, sodium thiosulfate, adrenal glands, parathyroid glands, nebivolol, nedocromil, nefazodone, nefopam, Neisseria catarrhalis, nelfinavir, neomycin, neostigmine, netilmicin, retina, nevirapine, niauli oil, nicardipine, nicergoline, nicethamide, nickel salts, niclosamide, nicoboxil, nicotine, nicotinamide, nicotinoylprocaine, nicotinic acid, kidneys, kidney stone, hellebore, Amer., hellebore, white, nifedipine, nifuratel, nilvadipine, nimodipine, nimorazole, nimustine, nisoldipine, nitrates, nitrazepam, nitrendipine, nitrofural, nitrofurantoin, nitroprusside sodium, nitroxoline, nizatidine, nonacog alpha, nonivamide, nonoxynol 9, nordazepam, norepinephrine, norethisterone, norfenefrine, norfloxacin, nor-gestimate, norgestrel, nortriptyline, noscapine, nystatin

femoral fascia, obidoxime chloride, ox gall, octenidine, octocog alpha (BHK), octodrine, octreotide, octyidiphenyl phosphate, agrimony, oleic acid, oleic acid polypeptide condensate, ofloxacan, Okoubaka, olaflur, olanzapine, oleander, oligodiiminoimido-carbonyliminohexamethylene, olive oil, olsalazine, omeprazole, ondansetron, opipramol, orciprenaline, organ extracts, organ mixture, orlistate, ornithine, ornithine aspartate, orotic acid, orotic acid, calcium salt, orotic acid, choline salt 1H2O, orotic acid, copper salt 2H2O, orotic acid, magnesium salt, orotic acid, zinc salt 2H2O, orphenadrine, orthosiphon, ouabain, oxaceprol, oxacillin, oxaliplatin, oxalic acid, oxazepam, oxcarbazepine, oxedrine, oxetacaine, oxiconazole, oxilofrin, oxitriptan, oxitropium bromide, 2-oxoglutaric acid, 4-oxopentanoic acid, calcium salt, oxophenylpropionic acid, oxprenolol, oxybuprocaine, oxybutynine, oxycodone, oxyfedrine, oxymetazoline, oxypolygelatine, oxytetracycline, oxytocin

paclitaxel, palivizumab, palladium, palmitic acid, palm lily, pamidronic acid, pancuronium bromide, pangamic acid, pancreas, pancreas powder, panthenol, pantoprazole, papain, poplar, paprika, paracetamol, paraffin, viscous, paraffin, mobile, paraffins, para cress, pareira root, paromomycin, paroxetin, passion flower, pegaspargase, pectin, pelargonium, pemolin, penbutolol, penciclovir, penicillamine, pentacalcium hydroxide trisphosphate, pentaerythritol, penta-erythrityl tetranitrate, pentamidine, pentazocine, pentifylline, pentostatin, pentoxifylline, pentoxy-verine, penty1cresol, pepsin, perazine, pergolide, perindopril, permethrin, perphenazine, pertactin, pertussis bacteria, Peru balsam, butterbur, parsley, pethidine, petroleum, pepper, peppermint, peppermint oil, pennycress, peony, phenamazide, phenazone, phenazopyridine, phenethyl alcohol, pheniramine, phenobarbital, phenol-methanal-urea polycondensate, sulfonated, phenolphthalein, phenoxybenzamine, phenoxyethanol, phenoxymethylpenicillin, phenoxymethyl-penicillin-benzathine, phenoxypropanol, phenprocoumon, phenylalanine, phenylbutazone, phenylephrine, phenyl-propanolamine, phenyltoloxamine, phenytoin, pholedrine, phospholipids, phospholipids from soybeans, phospho-lipids, essential, phosphonoserine, phosphorus, phosphoric acid, ortho-phthalaldehyde, physostigmine, phytomenadione, picric acid, pilocarpine, Pilocarpus species, fungal enzymes, pimento, pimozide, pindolol, α-pinene, β-pinene, Penicillium (frequentans), Penicillium (notatum), Penicillium (roqueforti), pioglitazone, pipamperone, pipemidic acid, pipenzolate bromide, piperacillin, piperonyl butoxide, pipoxolane, piprine hydrinate, piracetam, pirenoxine, pirenzepine, piretanide, piribedil, piritramide, piroxicam, pizotifen, placenta, plasma fibronectin, plasma proteins, human, plasma protein, human with factor VIII-inhibitor bypass activity, plasma protein, human with factor VIII correcting activity, plasma protein, animal, platinum, platinum chloride, Pneumococci bacteria, podophyllotoxin, mayapple, policresulene, polidocanol, polihexanide, poliomyelitis viruses, pollen, polyaziridine, polydimethylsilicone resin, polyestradiol phosphate, polyethylene, polygeline, polyisobutylene, poly-methacrylate, polymethyl methacrylate, polymethylolurea derivatives, polymyxin B, polysorbates, poly-styrenedivinylbenzenesulfonic acid, polythiazide, polyurethanes, polyvinyl alcohol, Seville orange, porfimer sodium, wild rosemary, potency wood, povidone, povidone-iodine, prajmalium bitartrate, pramipexol, prasterone, pravastatin, prazepam, praziquantel prazosine, prednicarbate, prednisolone, prednisone, prednylidene, pridinol, prilocaine, primidone, probenecid, procaine, procarbazine, procyclidine, progesterone, proglumetacin, proglumide, proguanil, proline, promazine, promethazine, propafenone, 1-propanol, 2-propanol, propicillin, Propionibacteria, propiverine, propofol, propolis, propranolol, propylene glycol, propyl hydroxybenzoate, propyl nicotinate, propylthiouracil, propyphenazone, proscillaridine, protamine hydrochloride, proteases, protein C, Proteus bacteria, prothipendyl, prothrombin, protionamide, protirelin, proxymetacaine, proxyphylline, Psorinum, pyolysine, Pyocyaneus bacteria, pyrantel, pyrazinamide, pyrethrum, pyridostigmine bromide, pyridoxine, pyrimethamine, pyrithione zinc, pyritinol, pyrvinium embonate

quebracho, couch grass, mercury, mercury(II) chloride, mercury(II) cyanide, mercury(II) cyanide oxide, mercury(II) iodide, mercury, soluble, mercury(II) oxide, red, mercury(II) sulfide, wild thyme, quetiapin, quinagolide, quinapril, quinaprilate, quinisocaine, quinupristine, quince

rabeprazole, [224Ra]radium chloride, tansy, raloxifen, ramipril, ranitidine, rasburicase, rhatany, rue, Rauwolfia, Rauwolfia vomitoria, water-hemlock, Wintergreen, reboxetin, remifentanil, repaglinide, reproterol, reserpine, resorcinol, reteplase, retinol, radish, reviparin sodium, rhubarb, rhododendron, ribavirine, riboflavine, riboflavine 5′-phosphate, ribonucleic acid, rifabutin, rifampicin, riluzole, rimexolone, marigold, risedronic acid, risperidone, ritonavir, rituximab, rivastigmine, rizatriptan, castor oil, refined, rizolipase, rocuronium bromide, rubella viruses, rofecoxib, ropinirol, ropivacaine, rosiglitazone, rosemary, horse chestnut, red beet, roxatidine, roxithromycin, spinal cord, everlasting, herb Robert, rutoside, rutoside, hydroxymethylated, rutoside sulfuric acid ester, sodium salt

sabadilla, savin, New Jersey tea, saw palmetto, safflower, saffron, sage, salbutamol, salicylamide, salicylic acid, salmeterol, Salmonella bacteria, nitric acid, nitric acid, homeopathic, hydrochloric acid, sandalwood, red, sea sedge, wood sanicle, yerba santa, saquinavir, sarsaparilla, common sorrel, wood sorrel, horsetail, yarrow, shale oil, refined, hemlock, thyroid gland, opium poppy, artery, blackthorn, candytuft, mucous membrane, primrose, snail extract, black haw, Japanese pagoda tree, celandine, swallowwort, black widow spider, sulfur, sulfur, finely divided, sulfur, colloidal, potassium sulfide, sulfuric acid, iris, iris, many-colored, scopolamine, secretin, common daphne, soap haw, selegiline, selenium, selenium disulfide, senega milkwort, senna, sepia, serine, serrapeptase, sertaconazole, sertraline, sevelamer, sevofluran, sibutramine, silver aminoethylphosphate, silver protein acetyltannate, silver, colloidal, silver, metall., silver nitrate, sildenafil, silbinine, silica, Simaruba root, simethicone, simvastatin, Siphonospora polymorpha, sirolimus, β-sitosterol, smectite, soybean, soybean lecithin, somatorelin, somatostatin, somatropin, sunflower, sunflower, tuberous, purple coneflower, pale, coneflower, purple, Echinacea augustifolia, rosemary sunrose, sundew, Candida albicans, sorbic acid, sorbitan sesquioleate, sorbitol, sotalol, asparagus, spectinomycin, spike lavender, spiramycin, spirapril, spironolactone, narrow-leaved plantain, starch hydrolyzate, staphylococci, stavudine, holly, kelp, white clover, coal tar, coal tar solution, stonecrop, stavesacre, star anise, Orostachys spinosa, pansy, asafetida, skunk, Stramonium, streptodornase, streptokinase, streptococci, streptococcal antigen, streptomycin, strontium carbonate, strontium chloride, Strophanthus, sucralphate, licorice plant, sufentanil, sulbactam, sulfacetamide, sulfadiazine, sulfadiazine silver, sulfalene, sulfamerazine, sulfamethoxazole, sulfasalazine, sulfate, sulpiride, sulprostone, sultamicillin, sultiam, sumatriptan, sumbul root, suxamethonium chloride, Syzygium

tobacco, tacalcitol, tacrolimus, talinol, tamoxifen, tamsulosan, tannin, tannin protein, tarantula, white dead-nettle, taurine, taurolidine, lesser centaury, tazarotene, tazobactam, tar, teicoplanin, telithromycin, telmisartan, temazepam, temozolomide, tenecteplase, teniposide, terazosine, terbinafine, terbutaline, terfenadine, terizidone, terlipressin, turpentine oil, terpine hydrate, testolactone, testosterone, testosterone enanthate, testosterone propionate, tetanus bacillus, tetraacetylethylene-diamine, tetrabromocresol, tetracaine, tetracosactide, tetracycline, tetrazepam, tetroxoprim, tetryzoline, Devil's bit scabious, Devil's claw, thallium acetate, thallium sulfate, theodrenaline, theophylline, theophylline-sodium glycinate, thiamazole, thiamine, thiamine dihydrogenphosphate, thiamine disulfide, thiamine nitrate, thiocyanate, thiopental sodium, thioridazine, thiotepa, threonine, thrombin, Thryallis, thyme, thymol, thymostimulin (calf), thymus gland, thyrotrophin, tiagabine, tiapride, tiaprofenic acid, tibolone, ticlopidine, animal charcoal, tiger lily, purging croton, tilidine, tiludronic acid, timolol, tinidazole, tinzaparine sodium, tioconazole, tioguanine, tiopronine, tioxolone, tirofiban, titanium dioxide, tizanidine, tobramycin, tocainide, α-tocopherol, RRR-α-tocopherol, α-tocopherol acetate, RRR-α-tocopherol acetate, DL-α-tocopherol hydrogensuccinate, RRR-α-tocopherol hydrogensuccinate, tolbutamide, tolciclate, deadly nightshade, rabies viruses, tolnaftate, tolonium chloride, tolperisone, tolterodine, clay, topiramate, topotecan, torasemide, toremifen, potentilla, tosylchloramide sodium, tramadol, tramazoline, trandolapril, tranexamic acid, tranylcypromine, trapidil, trastuzumab, travoprost, trazodone, treosulfan, tretinoin, triacylglycerol lipase, triamcinolone, triamcinolone acetonide, triamcinolone hexacetonide, triamterene, triazolam, tributyl-tetradecylphosphonium chloride, tributyltin benzoate, trichlormethiazide, Trichophyton antigen, Trichophyton fungus, triclocarban, triclosan, triflupromazine, trifluridine, triglycerides, medium chain, trihexyphenidyl, trimethoprim, trimethylhesperidine chalcone, trimipramine, tripelennamine, triptorelin, tritoqualine, trofosfamide, tromantadine, trometamol, tropalpine, tropicamide, tropisetrone, trospium chloride, troxerutin, trypsin, tryptophan, tuaminoheptane, tubercle bacteria (BCG), tuberculin, tulobuterol, tyloxapol, typhus live vaccine, typhus polysaccharide vaccine, tyramine, tyrosine, tyrothricin

elm, undecylenic acid, urapidil, uridine diphosphate, uridine mononophosphate, uridine triphosphate, urofollitropin, urokinase, ursodeoxycholic acid, Uzara,

valaciclovir, valine, valproic acid, valsartan, vanadium, vancomycin, varicella viruses, Vaseline, white, vecurornium bromide, venlafaxin, verapamil, verteporfin, vigabatrine, viloxazine, vinblastine, vincamine, vincristine, vindesine, vinorelbine, vinpocetine, knotgrass

juniper, juniper tar, pipsissewa, wood germander, clematis, walnut, warfarin, water, water fennel, hemp agrimony, Joe Pye weed, water hyacinth, duckweed, marsh pennywort, water hemlock, hydrogen peroxide, chicory, willow, frankincense, wine, red, hawthorn, wheat, wormwood, wasp, wasp toxin, wintergreen, horsetail, vertebral column, wolfsfoot, Virginian, gipsywort, American, gipsywort, European, wool wax alcohols, male fern, tansy

xanthan gum, xantinol nicotinate, xipamide, xylitol, xylometazoline

yam (HAB), yohimbe tree, yohimbine, tooth guard, toothpick weed, prickly ash, zalcitabin, zaleplone, zanamivir, bryony, zidovudine, cinnamon, cinnamon, chinese, zinc, zinc acetate, zinc aspartate, zinc chloride, zinc divalerate, zinc gluconate, zinc oxide, zinc phosphate, zinc sulfate, tin, pineal gland, zirconium oxide, lemon, citronella, aconite, zoledronic acid, zolmetriptan, zolpidem, zopiclone, zotepine, sugar syrup, zuclopenthixol, onion, diencephalon, cypress, cypress spurge.

Further suitable biologically active substances or materials are:

mafosfamide BNP 7787, D-63153, D-24851, D-70166, D-64131, cematodine LU 103793, LU 223651, A-299620, Onconase® ranpinase, ZD-6126 (ANG453), BMS-188797, BMS-275183, BMS-247550, paclitaxel, polyglutamate CT-2103/xyotax, E-7070 ER-35744, ABT-751/E-7010, cryptophycin 52 LY-355703, LY-290293, rhizoxine, anhydrovinblastine, cantuzumabmertansine HuC 242-DM1/SB408075, HuN901-DM1, MLN-591DM1, No 6529, IDN-5109, vincristine inex, vinca alkaloids, vincristine alza, dolastatin 10, combrestatin A-4, oxi-COM-102, ET-743 ecteinnascidin, isohomohalichondrin B, vinorelbine Navelbine® . . . ???, vinflunine F-12158, anhydrovinblastine, sosei, BIWI-1, soblidotin TZT-1027, griseofulvin transdermal, T-138067, T-900607, HTI-286, D-82318, discocdermolide analogs, NPI-2350, tubulin binding substances (tubulin-binding agents), DIME, VTA anticancer, glivec imatinib mesylate STI-571, IMC225 cetuximab, iressa gefitinib ZD 1839, Tarceva™ erlotinib OSI-774, CPG-41251, UCN-01, SU-6668 TSU-68, ZD 6474, TAK-165, vatalanib PTK-787/ZK-222584, Cl-1033 (PD-183805), PKI-1166 CGP-75166, GW-2016, EKB-569, ABX-EGF, IMC-1C11, semaxanib SU-5416

According to a further embodiment, a safety container according to one of the above aspects and embodiments is made available, characterized in that the biologically active substance is a cytotoxic substance.

Cytotoxic or alternatively generally cytotoxic substances within the meaning of the invention are in particular cytostatics (chemotherapeutics for the treatment of cancer), metastasis inhibitors and other antineoplastic agents, Suitable biologically active substances are furthermore protectives, such as mesna or BNP7787.

Suitable cytotoxic substances or protectives can furthermore be the substances mentioned below:

vinblastine, vincrystine, vindesine, vinorelbine, etoposide, teniposide, carmustine, nimustine, lomustine, cyclophosphamide, estramustine, melphalan, ifosfamide, trofosfamide, chlorambucil, bendamustine, darcabazine, busulfan, procarbazine, treosulfan, temozolomide, thiotepa, daunorubicin, doxorubicin, epirubicin, mitoxantrone, indarubicin, bleomycin, mitomycin, dactinomycin, methotrexate, fludarabine phosphate, cladribine, mercaptopurine, tioguanine, cytarabine, fluorouracil, gemcitabin, capecitabin, paclitaxel (Taxol®), docetaxel, carboplatin, cisplatin, oxaliplatin, amsacrine, irinotecan, topotecan, interferon alpha-2b, interferon alpha-2a hydroxycarbamide, miltefosin, pentostatin, porfimer sodium, aldesleukin, tretinoin, asparaginase, pegaspargase, trastuzumab, alemtuzumab, rituximab, polyestradiol phosphate, fosfestrol, ethinylestradiol, medroxyprogesterone acetate, gestonorone caproate, megestrol acetate, norethisterone, lynestrenol, buserelin, triptorelin, leuprorelin, goserelin, testolactone, testosterone, tamoxifen, toremifen, flutamide, bicatulamide, cyproterone, anastrozole, exemestan, letrozole, formestan, aminoglutethimide, calcium folinate, amifostin, rasburicase, lenograstim,

molgramostime, filgrastime, mesna (protective), BNP7787 (protective)

Further examples of biologically active substances are: inorganic and organic active compounds, inorganic or organic toxins, vaccines, viruses, bacteria, vectors

Vaccines: hepatitis, rubella, diphtheria, polio, poxes, tetanus, cholera, measles, mumps, meningococci, FSME, gas gangrene, influenza Cytostatics (organic): cyclophosphamide, fluorouracil, cisplatin, ifosfamide, trofosfamide, carmustine, lomustine, vinblastine, vincristine, vindesine, vinorelbine, etoposide, teniposide, nimustine, mitoxantrone, methotrexate, oxaliplatin, taxol, mafosfamide, carboplatin

Further suitable biologically active materials are mentioned below:

| | |
|---|---|
| Live vaccines | Vaccinia virus |
| | Polio virus |
| | Mumps, measles and |
| | rubella vaccine |
| Gene therapy vectors | Adenovirus vectors |
| | Retrovirus vectors |
| | AAV vectors |
| DNA vaccines | Plasmid DNA vectors |
| | HIV, HCV, DNA |
| | vectors |
| Recombinant live | chimeric flavivirus |
| vaccines | vectors (chimerivax |
| | vectors) |
| general: organisms of | according to EU |
| biosafety stages numeral | guidelines |
| 1-4 | 90/219/EEC, |
| | 98/81//EC, to which |
| | reference is hereby |
| | made |

Further suitable biologically active substances according to the invention as set forth in the NIH Guidelines for Research Involving Recombinant DNA Molecules (NIH Guidelines) in the version of Apr. 2002 are mentioned below (see pages 28-36):

Appendix A-I.

Sublist A

Genus Escherichia

Genus Shigella

Genus Salmonella- including Arizona

Genus Enterobacter

Genus Citrobacter- including Levinea

Genus Klebsiella-including oxytoca

Genus Erwinia

Pseudomonas aeruginosa, Pseudomonas putida, Pseudomonas fluorescens, and Pseudomonas mendocina

Serratia marcescens

Yersinia enterocolitica

Appendix A-II.

Sublist B

Bacillus subtilis

Bacillus licheniformis

Bacillus pumilus

Bacillus globigii

Bacillus niger

Bacillus nato

Bacillus amyloliquefaciens

Bacillus aterrimus

Appendix A-III.

Sublist C

Streptomyces aureofaciens

Streptomyces rimosus

Streptomyces coelicolor

Appendix A-IV, Sublist D

Streptomyces griseus

Streptomyces cyaneus

Streptomyces venezuelae

Appendix A-V.

Sublist E

One-way Transfer of Streptococcus mutans or Streptococcus lactis

DNA to Streptococcus sanguis

Appendix A-VI.

Sublist F

Streptococcus sanguis

Streptococcus pneumoniae

Streptococcus faecalis

Streptococcus pyogenes

Streptococcus mutans

APPENDIX B.

Classification of Human Etiological Active Compounds According to Danger

This appendix comprises those biological active compounds or agents of which it is known that they to humans and selected animal agents which are a theoretical risk if the human inoculates.

Attached are lists of representative genera and species of which it is known that they are pathogenic.

Appendix B—Table 1.

Basis for the Classification of Biohazardous Active Compounds (Agents) According to Risk Groups (RG)

Risk group 1 (RG1) Agents which are not associated with diseases of healthy adult humans

Risk group 2 (RG2) Agents which are associated with human diseases which are rarely serious and for which preventive or therapeutic interventions are often available.

Risk group 3 (RG3) Agents which are associated with serious and fatal diseases for which preventive or therapeutic interventions are possibly available (high individual risk but low risk to the community).

Risk group 4 (RG4) Agents which probably cause serious and fatal diseases in humans, for which preventive or therapeutic interventions are customarily not available (high individual risk and high risk to the community)

Appendix B-I.

Risk Group 1 (RG1) Agents

RG1 agents are not associated with diseases of healthy adult humans. Examples of RG1 agents include:

asporogenic Bacillus subtilis or Bacillus licheniformis (see Appendix C-IV-A, Bacillus subtilis or Bacillus licheniformis host-vector systems, exceptions); adeno-associated virus (MV) types 1 to 4; and

recombinant AAV constructs, in which the transgene does not code for either a potential tumorigenic product or a toxin molecule and which are produced in the absence of helper virus. A strain of Escherichia coli (see appendix C-II-A, Escherichia coli K-12 host-vector systems, exceptions) is an RG1 agent if (1) it does not possess a complete not lipopolysaccharide (i.e., it lacks the O antigen); and (2) carries no active virulence factor (e.g., toxins) or colonization factors and carries no genes which code for such factors.

The agents according to assignment to the risk groups (RGs) 2, 3 and 4 are not automatically or implicitly classified in RG1; an estimation of the risk must be carried out on the basis of their known or potential properties and their relationships to the agents listed.

Appendix B-II.

Risk Group 2 (RG2) Agents

(RG2) agents are associated with human diseases which are rarely serious and for which preventive or therapeutic interventions are often available.

Appendix B-II-A, Risk Group 2 (RG2)—Bacterial Agents Including Chlamydia
Acinetobacter baumannii (formerly Acinetobacter calcoaceticus)
Actinobacillus
Actinomyces pyogenes (formerly Corynebacterium pyogenes)
Aeromonas hydrophila
Amycolata autotrophica
Archanobacterium haemolyticum (formerly Corynebacterium haemolyticum)
Arizona hinshawii—all serotypes
Bacillus anthracis
Bartonella henselae, B. quintana, B. vinsonii
Bordetella including B. pertussis
Borrelia recurrentis, B. burgdorferi
Burkholderia (formerly Pseudomonas species) excluding those listed in Appendix B-III-A (RG3)
Campylobacter coli, C. fetus, C.jejuni
Chlamydia psittaci, C. trachomatis, C. pneumoniae
Clostridium botulinum, Cl. chauvoei, Cl. haemolyticum, Cl. histolyticum, Cl. novyi, Cl. septicum, Cl. tetani
Corynebacterium diphtheriae, C. pseudotuberculosis, C. renale
Dermatophilus congolensis
Edwardsiella tarda
Erysipelothrix rhusiopathiae
Escherichia coli—all enteropathogenic, entero-toxigenic, enteroinvasive and strains which carry K1 antigen, including E coli O157:H7
Haemophilus ducreyi, H. influenzae
Helicobacter pylori
Klebsiella—all species excluding K. oxytoca (RG1)
Legionella including L. pneumophila
Leptospira interrogans—all serotypes
Listeria
Moraxella
Mycobacterium (excluding those listed in Appendix B-III-A (RG3)) including M. avium complex, M asiaticum, M. bovis BCG vaccine strain, M. chelonei, M. fortuitum, M. kansasii, M. leprae, M. malmoense, M. marinum, M. paratuberculosis, M. scrofulaceum, M. simiae, M. szulgai, M. ulcerans, M. xenopi
Mycoplasma, excluding M. mycoides and M. agalactiae which are restricted animal pathogens
Neisseria gonorrhoeae, N. meningitidis
Nocardia asteroides, N. brasiliensis, N. otitidiscaviarum, N. transvalensis
Rhodococcus equi
Salmonella incl. S. arizonae, S. cholerasuis, S. enterididis, S. gallinarum-pullorum, S. meleagridis, S. paratyphi, A, B, C, S. typhi, S. typhimurium
Shigella incl. S. boydii, S. dysenteriae, type 1, S. flexneri, S. sonnei
Sphaerophorus necrophorus
Staphylococcus aureus
Streptobacillus moniliformis
Streptococcus incl. S. pneumoniae, S. pyogenes
Treponema pallidum, T. carateum
Vibrio cholerae, V. parahemolyticus, V. vulnificus
Yersinia enterocolitica

Appendix B-II-B.

Risk Group 2 (RG2)—

Fungal Agents
Blastomyces dermatitidis
Cladosporium bantianum, C. (Xylohypna) trichoides
Cryptococcus neoformans
Dactylaria galopava (Ochroconis gallopavum)
Epidermophyton
Exophiala (Wangiella) dermatitidis
Fonsecaea pedrosoi
Microsporum
Paracoccidioides braziliensis
Penicillium marneffei
Sporothrix schenckii
Trichophyton

Appendix B-II-C, Risk Group 2 (RG2)—Parasitic Agents
Ancylostoma human hookworms including A. duodenale, A. ceylanicum
Ascaris including Ascaris lumbricoides suum
Babesia including B. divergens, B. microti
Brugia filaria worms including B. malayi, B. timori
Coccidia
Cryptosporidium including C. parvum
Cysticercus cellulosae (hydatid cyst, larva of T. solium)
Echinococcus including E. granulosis, E. multilocularis, E. vogeli
Entamoeba histolytica
Enterobius
Fasciola including F. gigantica, F. hepatica
Giardia including G. lamblia
Heterophyes
Hymenolepis including H. diminuta, H. nana
Isospora
Leishmania including L. braziliensis, L. donovani, L. ethiopia, L. major, L. mexicana, L. peruvania, L. tropica
Loa loa filaria worms
Microsporidium
Naegleria fowleri
Necator human hookworms including N. americanus
Onchocerca filaria worms including O. volvulus
Plasmodium including simian species, P. cynomologi, P. falciparium, P. malariae, P. ovale, P. vivax
Sarcocystis including S. sui hominis
Schistosoma including S. haematobium, S. intercalatum, S. japonicum, S. mansoni, S. mekongi
Strongyloides including S. stercoralis
Taenia solium
Toxocara including T. canis
Toxoplasma including T. gondii
Trichinella spiralis
Trypanosoma including T. brucei brucei, T. brucei gambiense, T. brucei rhodesiense, T. cruzi
Wuchereria bancrofti filaria worms

Appendix B-II-D.

Risk Group 2 (RG2)—

Viruses

Adenoviruses, human—all types

Alphaviruses (togaviruses)—group A arboviruses
Eastern equine encephalomyelitis virus
Venezuelan equine encephalomyelitis vaccine strain TC-83
Western equine encephalomyelitis virus Arenaviruses
Lymphocytic choriomeningitis virus (non-neurotropic strains)
Tacaribe virus complex
Other viruses according to the listing in: U.S. Department of Health and Human Services, Public Health Service, Centers for Disease Control and Prevention and the National Institutes of Health. Biosafety in Microbiological and Biomedical Laboratories, 4th Edition, 1999 (copies are obtainable from: Superintendent of Documents, U.S. Government Printing Office, Washington, D.C. 20402-9371 (Stock # 017-040-00547-4), Phone (202) 512-1800).

Bunyaviruses
Bunyamwera virus
Rift Valley Fever virus vaccine strain MP-12
Other viruses according to the listing in: U.S. Department of Health and Human Services, Public Health Service, Centers for Disease Control and Prevention and the National Institutes of Health. Biosafety in Microbiological and Biomedical Laboratories, 4th Edition, 1999 (see above)

Calciviruses

Coronaviruses

Flaviviruses (togaviruses)—

group B arboviruses
Dengue virus serotypes 1, 2, 3, and 4
Yellow fever virus vaccine strain 17D
Other viruses according to the listing in: U.S. Department of Health and Human Services, Public Health Service, Centers for Disease Control and Prevention and the National Institutes of Health. Biosafety in Microbiological and Biomedical Laboratories, 4th Edition, 1999

Hepatitis A, B, C, D, and E viruses

Herpesviruses—excluding herpesvirus simiae (Monkey B virus) (see Appendix B-IV-D, risk group 4 (RG4)—Viral agents)
Cytomegalovirus
Epstein Barr virus
Herpes simplex types 1 and 2
Herpes zoster
Human herpesvirus types 6 and 7

Orthomyxoviruses
Influenza viruses types A, B, and C
Other tick-borne orthomyxoviruses according to the listing in: U.S. Department of Health and Human Services, Public Health Service, Centers for Disease Control and Prevention and the National institutes of Health. Biosafety in Microbiology and Biomedical Laboratories, 4th Edition, 1999

Papovaviruses
All human papilloma viruses

Paramyxoviruses
Newcastle disease virus
Measles virus
Mumps virus
Parainfluenza viruses types 1, 2, 3, and 4
Respiratory syncytial virus

Parvoviruses
Human parvovirus (B19)

Picornaviruses
Coxsackie viruses types A and B
Echoviruses—all types
Polioviruses—all types, wild and attenuated
Rhinoviruses—all types

Poxviruses—all types excluding monkeypox virus (see Appendix B-III-D, Risk group 3 (RG3)—viruses and prions) and restricted pox viruses including alastrim, smallpox, and whitepox

Reoviruses—all types including coltivirus, human rotavirus, and orbivirus (Colorado tick fever virus)

Rhabdoviruses
Rabies virus—all strains
Vesicular stomatitis virus—laboratory adapted strains including VSV-Indiana, San Juan, and Glasgow

Togaviruses (see alphaviruses and flaviviruses)
Rubivirus (rubella)

Appendix B-III.

Risk Group 3 (RG3) Agents

RG3 agents which are associated with serious and fatal diseases for which preventive or therapeutic interventions are possibly available (high individual risk but low community risk).

Appendix B-III-A.

Risk group 3 (RG3)—Bacterial Agents Including Rickettsia
Bartonella
Brucella including B. abortus, B. canis, B. suis
Burkholderia (Pseudomonas) mallei, B. pseudomallei
Coxiella burnetii
Francisella tularensis
Mycobacterium bovis (excluding BCG strain, see Appendix B-II-A, risk group 2 (RG2)—bacterial agents including Chlamydia), M. tuberculosis
Pasteurella multocida type B—“buffalo” and other virulent strains
Rickettsia akari, R. australis, R. canada, R. conorii, R. prowazekii, R. rickettsii, R. siberica, R. tsutsugamushi,

R. typhi (R. mooseri)
Yersinia pestis

Appendix B-III-B;

risk group 3 (RG3)—Fungal Agents
Coccidioides immitis (sporulating cultures; contaminated earth)
Histoplasma capsulatum, H. capsulatum var. duboisii

Appendix B-III-C.

Risk Group 3 (RG3)—Parasitic Agents None

Appendix B-III-D.

Risk Group 3 (RG3)—Viruses and Prions

Alphaviruses (Togaviruses)—Group A Arboviruses
Semliki Forest virus
St. Louis encephalitis virus
Venezuelan equine encephalomyelitis virus (excluding the vaccine strain TC-83, see Appendix B-II-D (RG2))
Other viruses according to the listing in the reference source (see Section V-C, Footnotes and References of Sections I to IV)

Arenaviruses
Flexal
Lymphocytic choriomeningitis virus (LCM) (neurotropic strains) Bunyaviruses
Hantaviruses including Hantaan virus
Rift Valley fever virus

Flaviviruses (togaviruses)—group B arboviruses
Japanese encephalitis virus
Yellow fever virus
Other viruses according to the listing in: U.S. Department of Health and Human Services, Public Health Service, Centers for Disease Control and Prevention and the National Institutes of Health. Biosafety in Microbiological and Biomedical Laboratories, 4th Edition, 1999

Poxviruses
Monkeypox virus

Prions
Transmissible spongioform encephalopathies (TME) agents (Creutzfeldt-Jacob disease and kuru agents) Retroviruses
Human immunodeficiency virus (HIV) Types 1 and 2
Human T cell lymphotropic virus (HTLV) Types 1 and 2
Simian immunodeficiency virus (SIV)

Rhabdoviruses
Vesicular stomatitis virus

Appendix B-IV.

Risk group 4 (RG4) agents (RG4) agents which probably cause serious and fatal diseases in humans, for which preventive or therapeutic interventions are customarily not available (high individual risk and high community risk)

Appendix B-IV-A.

Risk group 4 (RG4)—Bacterial Agents

none

Appendix B-IV-B.

Risk group 4 (RG4)—Fungal Agents

none

Appendix B-IV-C.

Risk group 4 (RG4)—Parasitic Agents

none

Appendix B-IV-D.

Risk Group 4 (RG4)—Viral Agents Arenaviruses
Guanarito virus
Lassa virus
Junin virus
Machupo virus
Sabia

Bunyaviruses (nairovirus)
Crimean-Congo hemorrhagic fever virus

Filoviruses
Ebola virus
Marburg virus

Flaviviruses (togaviruses)—Group B Arboviruses
Tick-borne encephalitis virus complex including Absetterov, Central European encephalitis, Hanzalova, Hypr, Kumlinge, Kyasanur Forest disease, Omsk hemorrhagic fever, and Russian spring-summer encephalitis viruses

Herpesviruses α
Herpesvirus simiae (herpes B or monkey B virus)

Paramyxoviruses
Equine morbillivirus
Hemorrhagic fever agents and viruses as yet still undefined

Appendix B-V.

Animal Viral Etiologic Agents in Common Use

To the following list of animal etiologic agents is appended to the list of human etiologic agents. None of the agents is associated with diseases of healthy adult humans. They are customarily used for laboratory experiments. Certain agents, e.g. amphotropic and xenotropic strains of murine leukaemia virus, can infect human cells.

Baculoviruses

Herpesviruses
Herpesvirus ateles
Herpesvirus saimiri
Marek's disease virus
Murine cytomegalovirus

Papovaviruses
Bovine papilloma virus
Polyoma virus
Shope papilloma virus
Simian virus 40 (SV40)

Retroviruses
Avian leukosis virus
Avian sarcoma virus
Bovine leukemia virus
Feline leukemia virus
Feline sarcoma virus
Gibbon leukemia virus
Mason-Pfizer monkey virus
Mouse mammary tumor virus
Murine leukemia virus
Murine sarcoma virus
Rat leukemia virus

Appendix B-V-1.

Murine Retroviral Vectors

Murine retroviral vectors are used for human transfer experiments.

According to a further embodiment, a safety container according to one of the above aspects and embodiments is made available, characterized in that the cytotoxic substance has been selected from the group consisting of ifosfamide, cyclophosphamide, trofosfamide, mafosfamide, acridine derivatives according to International patent application No. PCT/US98/532 filed on Jan. 6, 1998 (WO 98/30545), such as, for example, the compound S303 (β-alanine N-acridin-9-yl-2[bis(2-chloroethyl)amino]ethyl ester) described there on pages 32-40, mitoxantrone, LHRH agonists, LH-RH antagonists such as, for example, cetrorelix, teverelix or the LH-RH antagonists according to International patent applications PCT/EP00/02165 filed on Mar. 11, 2000 and PCT/EP01/02719 filed on Mar. 12, 2001, such as, for example, the LH-RH antagonist D-63153 (Ac—D—Nal(2)-D—Cpa—D—Pal(3)—Ser—N—Me—Tyr—D—Hci—Nle—Arg—Pro—D—Ala—NH₂ described there, e.g. as the acetate salt; CAS 295350-45-7), N-substituted indole-3-glyoxylamides according to International patent applications No. PCT/EP97/04474 filed on Aug. 16, 1997, PCT/EP99/01918 filed on Mar. 22, 1999, and PCT/EP00/09390 filed on Sep. 26, 2000, such as, for example, the tubulin inhibitor D-24851 (N-pyridyl-4-yl)-[1-(4-chlorobenzyl)indol-3-yl]-glyoxylamide) described there, glufosfamide, mesna (e.g. as a protective) and BNP7787 (dimesna, 2,2′-dithiobisethanesulfonate, e.g. as the disodium salt) (e.g. as a protective).

According to a further embodiment, a safety container according to one of the above aspects and embodiments is made available, characterized in that the coating has been attached by means of the steps i) treatment of the filled, sealed and optionally labeled container with a medium which contains at least one polymer, and ii) subsequent drying of the container treated with the medium.

According to a further embodiment, a safety container according to one of the above aspects and embodiments is made available, characterized in that the treatment has been carried out by spraying.

According to a further embodiment, a safety container according to one of the above aspects and embodiments is made available, characterized in that the spraying has been carried out by use of shear forces (e.g. use of a nozzle) and/or use of flow forces (e.g. use of a rotating disk).

According to a further embodiment, a safety container according to one of the above aspects and embodiments is made available, characterized in that the treatment has been carried out by immersion.

According to a further embodiment, a safety container according to one of the above aspects and embodiments is made available, characterized in that the treatment has been carried out by applying a powder.

According to a further embodiment, a safety container according to one of the above aspects and embodiments is made available, characterized in that at least one medium from the group consisting of powder, dispersion, emulsion, suspension, solution and multicomponent systems (e.g. two- or three-component systems; the individual components are brought together only shortly before attachment) containing polymer has been selected.

According to a further embodiment, a safety container according to one of the above aspects and embodiments is made available, characterized in that the polymer has been selected from the group consisting of polyurethane, polyester and polyester-polyurethane mixtures.

According to a further aspects of the present invention, a process for the production of a filled, sealed and optionally labeled safety containers for biologically active substances having increased or high fracture strength and shatterproof strength, and a contamination-free outer surface is made available, the container comprising a hollow body having at least one opening, one closure each per opening, optionally a marking, and at least one biologically active substance filled into the hollow body and a coating having been completely or partially attached to the outside of the filled, sealed and optionally labeled container, characterized by the steps i) treatment of the filled, sealed and optionally labeled container with a medium which contains at least one polymer, and ii) drying of the container treated with the medium.

The process can be carried out in a simple manner. A particular advantage consists in the fact that the process according to the invention can be tailored to all customary container forms and sizes in a manner which is simple and rapid to carry out. On account of this, no or only small setup times result, therefore also shorter or no machine stoppage times, no or lower storage costs for shaped parts and altogether lower production costs per safety container are obtained.

According to a particular embodiment, a process according to the abovementioned aspect of the present invention is provided, characterized in that before the treatment the filled, sealed and optionally labeled container is treated with a wash medium (e.g. water for injection (WFI) or, if WFI is not necessary, also water of a lower water quality can be employed).

Preferably, the washed containers are subsequently dried under flows of air or nitrogen. Customarily, a visual check for complete dryness is carried out. Extensive dryness is a prerequisite for subsequent possible writing or labeling. If coating is carried out before the attachment of the writing, residual amounts of WFI (=water for injection) are not a nuisance if water-soluble polymer coatings are used.

According to a further embodiment, a process according to one of the abovementioned aspects and embodiments is made available, characterized in that the treatment is carried out at approximately room temperature (for example 20° C.-25° C).

According to a further embodiment, a process according to one of the abovementioned aspects and embodiments is made available, characterized in that the drying is carried out at approximately room temperature (for example 20° C.-25° C).

According to a further embodiment, a process according to one of the abovementioned aspects and embodiments is made available, characterized in that the coating is attached completely or almost completely to the container.

According to a further embodiment, a safety container according to one of the above aspects and embodiments is made available, characterized in that the container is manufactured from glass, plastic or glass coated with plastic on the inside or outside.

Suitable kinds of glass are, for example, the glass types I-III. Glass type I can be used, for example, in the case of liquid products and glass type III, for example, for solids. The composition of the glass types is described in the USP (USP 26-2003; chapter 661 Containers; pages 2142-2145) and EP (EP 4th edition: basic work 2002; chapter 3.2 Behältnisse [Containers]; pages 331-335). The size of the containers employed can vary within wide ranges from very small up to very large containers.

Suitable plastics are, for example, polyethylene, polypropylene, polyvinyl chloride and Topas® (cyclo-olefin copolymer from Ticona). The requirements for plastic containers are described in the USP and EP (USP 26-2003; chapter 661 Containers; pages 2142-2143; 2145-2148; EP 4th edition: basic work 2002; chapter 3.2 Behältnisse [Containers]; pages 331; 335 343). The size of the containers employed can vary within wide ranges from very small up to very large containers.

According to a further embodiment, a process according to one of the abovementioned aspects and embodiments is made available, characterized in that it comprises at least one closure, for example consisting of a rubber stopper and a crimped cap, or of an alternative closure system.

Further suitable closure systems can be:

rubber stopper and Bioset®; rubber disk and crimped cap; closure systems from Becton & Dickinson, glass seals with or without an intended point of fracture.

According to a further embodiment, a process according to one of the above aspects and embodiments is made available, characterized in that the marking is a marked or marking surface, preferably a marked label of paper and/or plastic.

According to a further embodiment, a process according to one of the above aspects and embodiments is made available, characterized in that the biologically active substance has a liquid, solid or amorphous physical state at room temperature.

According to a further embodiment, a process according to one of the abovementioned aspects and embodiments is made available, characterized in that the biologically active substance is a cytotoxic substance.

Suitable biologically active substances or materials cytotoxic substances as already mentioned in greater detail above.

According to a further embodiment, a process according to one of the abovementioned aspects and embodiments is made available, characterized in that the cytotoxic substance has been selected from the group consisting of ifosfamide, cyclophosphamide, trofosfamide, mafosfamide, S303, mitoxantrone, an LHRH agonist such as, for example, D-63153, mesna (e.g. as a protective), BNP7787 (e.g. as a protective) and glufosfamide.

Suitable cytotoxic substances are those as already mentioned in greater detail above.

According to a further embodiment, a process according to one of the abovementioned aspects and embodiments is made available, characterized in that the treatment has been carried out by spraying.

According to a further embodiment, a process according to one of the abovementioned aspects and embodiments is made available, characterized in that the spraying has been carried out by use of shear forces (e.g. use of a nozzle) and/or use of flow forces (e.g. use of a rotating disk).

According to a further embodiment, a process according to one of the abovementioned aspects and embodiments is made available, characterized in that the treatment has been carried out by immersion.

According to a further embodiment, a process according to one of the above aspects and embodiments is made available, characterized in that the treatment is carried out by applying a powder.

According to a further embodiment, a process according to one of the abovementioned aspects and embodiments is made available, characterized in that the medium containing at least one polymer has been selected from from the group consisting of powder, dispersion, emulsion, suspension, solution and multicomponent systems (e.g. two- or three-component systems; the individual components are brought together shortly before application).

According to a further embodiment, a process according to one of the abovementioned aspects and embodiments is made available, characterized in that the polymer has been selected from the group consisting of polyurethane, polyester and polyester-polyurethane mixtures.

According to a further aspect of the present invention, a safety container for biologically active substances having increased or high fracture strength and shatterproof strength, and a contamination-free outer surface is made available, which can be prepared as set forth in the process according to one of the abovementioned aspects and embodiments.

According to a further aspect of the present invention, the use of a medium which contains at least one polymer for the treatment of a filled, sealed and optionally labeled container for biologically active substances is made available, the container comprising a hollow body provided with at least one opening, one closure each per opening, a marking and at least one biologically active substance filled into the hollow body and, by means of the treatment with the medium, a coating being applied to the outside of the filled, sealed and optionally labeled container.

The coating can be carried out in a single or in multiple working steps. Multiple coating can be carried out simultaneously to the first coating, after application and before the drying of the first layer or after the application and drying of the first layer. What has just been said accordingly applies to the application of a third or further layer.

In the case where a number of layers are applied, the properties of the layers can be different, for example the adhesiveness of the first layer applied to the container material can be particularly advantageous and the second layer can have a particularly advantageous abrasion resistance. The person skilled in the art will coordinate the properties of the individual layers such that the properties of the safety container according to the invention are particularly advantageous.

According to a further aspect of the present invention, the use of a medium which contains at least one polymer for the decontamination of the outer surface and/or increase in the fracture strength and shatterproof strength of a container for biologically active substances filled with a biologically active substance, sealed and optionally labeled is made available, the container comprising a hollow body provided with at least one opening, one closure each per opening, a marking and at least one biologically active substance filled into the hollow body and the decontamination being carried out by applying a coating to the outside of the filled, sealed and optionally labeled container.

According to a particular embodiment, the use according to one of the abovementioned aspects and embodiments is made available, characterized in that before the treatment the filled, sealed and optionally labeled container is treated with a wash medium (as a rule WFI water). Preferably, the washed containers are subsequently dried under flows of air or nitrogen. Customarily, a visual check for complete dryness is carried out. Extensive dryness is a prerequisite for subsequent possible marking. If the coating takes place before the attachment of the marking, small residual amounts of WFI water are not a nuisance in the case of the use of water-soluble polymer coatings.

According to a further embodiment, the use according to one of the abovementioned aspects and embodiments is made available, characterized in that the treatment is carried out at approximately room etemperature (for example 20° C.-25° C.).

According to a further embodiment, the use according to one of the abovementioned aspects and embodiments is made available, characterized in that the drying is carried out at approximately room temperature (for example 20° C.-25° C.).

According to a further embodiment, the use according to one of the abovementioned aspects and embodiments is made available, characterized in that the coating is attached completely or almost completely to the container.

According to a further embodiment, the use according to one of the abovementioned aspects and embodiments is made available, characterized in that the container has been manufactured from glass, plastic or glass coated with plastic on the inside or outside. As already described above, suitable materials are, for example, the following kinds of glass: both blown glass and tube glass in the glass qualities I, II and III (according to USP=American pharmacopeia and/or EP=European pharmacopeia).

As already described above, suitable materials are the following plastics: Topas®, which is the trade name for cycloolefin copolymers (amorphous thermoplastics) of Ticona, polypropylene, HD and LD polyethylene, polyvinyl chloride.

The following container types and shapes are, for example, suitable: vials for single or multiple withdrawal, infusion bottles or bags, ampoules, carpules or syringe molded articles.

According to a further embodiment, the use according to one of the abovementioned aspects and embodiments is made available, characterized in that it comprises at least one closure, e.g. consisting of a rubber stopper and a crimped cap or of an alternative closure system.

Further suitable closures, for example, are as already described above: adapter systems e.g. Bioset Luer, Bioset Infusion (Baxter).

According to a further embodiment, the use according to one of the abovementioned aspects and embodiments is made available, characterized in that the marking is a marking surface, preferably a marked label made of paper and/or plastic.

Further suitable markings are: direct printing, e.g. in the screen printing process. The label printing can be carried out both in-line in the labeling machine (white line technology) and off-line at the label producer.

According to a further embodiment, the use according to one of the abovementioned aspects and embodiments is made available, characterized in that the biologically active substance has a liquid, solid or amorphous physical state at room temperature.

Further suitable forms of the biologically active substance are, for example: lyophilizate with or without additives, crystallizate with or without additives, injection solution, powder, molded articles (rods) for implantation (polylactic acid).

According to a further embodiment, the use according to one of the abovementioned aspects and embodiments is made available, characterized in that the biologically active substance is a cytotoxic substance.

According to a further embodiment, the use according to one of the abovementioned aspects and embodiments is made available, characterized in that the cytotoxic substance has been selected from the group consisting of ifosfamide, cyclophosphamide, trofosfamide, mafosfamide, S303, mitoxantrone, LHRH antagonists, mesna (e.g. as a protective), BNP7787 (e.g. as a protective) and glufosfamide.

According to a further embodiment, the use according to one of the abovementioned aspects and embodiments is made available, characterized in that the treatment has been carried out by spraying.

According to a further embodiment, the use according to one of the abovementioned aspects and embodiments is made available, characterized in that the spraying has been carried out by use of shear forces (e.g. use of a nozzle) and/or use of flow forces (e.g. use of a rotating disk).

According to a further embodiment, the use according to one of the abovementioned aspects and embodiments is made available, characterized in that the treatment has been carried out by immersion.

According to a further embodiment, the use according to one of the above aspects and embodiments is made available, characterized in that the treatment is carried out by applying a powder. The application of the powder can be carried out, for example, by electrostatic spraying.

According to a further embodiment, the use according to one of the abovementioned aspects and embodiments is made available, characterized in that the medium containing at least one polymer has been selected from the group consisting of powder, dispersion, emulsion, suspension and, solution and multicomponent systems (e.g. two-or three-component systems; the individual components are brought together only shortly before application).

According to a further embodiment, the use according to one of the abovementioned aspects and embodiments is made available, characterized in that at least one polymer which is contained in the medium has been selected from the group consisting of polyurethane, polyester and polyester-polyurethane mixtures.

Further suitable polymers for coating are: polystyrenes, polyethylenes, polypropylenes, acrylic copolymers, polycarbonates, poly(methyl) methacrylates, epoxy resins, butadiene copolymers, polyolefins, acrylic resins, methacrylic resins, ethylene-vinyl acetate copolymers, vinyls, vinyl chlorides, polyvinylidene chloride, polyamides, ionomeric polyamides, acrylonitriles, acrylonitrile-butadiene-styrene resins, and mixtures thereof.

The medium which contains at least one polymer can contain additives such as, for example, inorganic colorants (pigments) or organic dyes or lightscreen factors against visible and/or UV light (thereby additional lightscreen effect). Further additives can, alone or in combination with the aforementioned additives, in suitable amount in each case, be catalysts for the polymerization of components, defoaming agents, flow and leveling agents, rheology modifiers, photostabilizers or their combinations.

### DETAILED ILLUSTRATION OF THE INVENTION

The coated safety containers should preferably fulfill one, some or all of the following properties/criteria:
Transparency (transparent appearance) and freedom from bubbles (without causing bubbling):
The transparency is assessed by means of a visual test. Checking of the contents must be possible! Moreover, the coating should be examined for freedom from bubbles. Air bubbles in the coating lead to a lowering of the protective function.
Smoothness (smooth) and nontackiness:
By means of haptic testing it can be checked whether the surface is not too rough and whether it remains sticky to the hand or glove of the tester. The coating should be of similar smoothness to the container surface and must stick nowhere later during handling.
Piercing strength or shatterproof protection and fracture strength:
Using a fall test according to DIN 55441-2 (free fall), the impact strength of the safety container can be tested. Particular important criteria are the fracture strength and the shatterproof protection.
Glidability (important for further processing)
The friction behavior can be tested by the determination of the adhesion and gliding friction values according to DIN 53375.
Insensitivity (resistance) to temperature variations (resistant to temperature change) and customary detergents

Stability testing according to ICH Q1 (International Conference of Harmonization, resistant to conventional detergent systems—stability testing).

| Criterion | Testing | Comment/note |
|---|---|---|
| Transparency | visual | Important for checking the |
| | | contents! |
| Smoothness | haptic | Coating should be of similar |
| | | smoothness to the substrate |
| Tackiness | haptic | Coating must stick nowhere |
| | | during handling |
| Freedom from | visual | Inclusions of air can lower the |
| bubbles | | protective function |
| Piercing strength | DIN 55441-2 | Packaging testing; impact |
| | | testing (free fall) |
| Shatterproof | DIN 55441-2 | See above |
| protection | | |
| Fracture | DIN 55441-2 | See above |
| protection | | |
| Glidability | DIN 53375 | Friction behavior important for |
| | | further processing |
| Temperature and | Stability testing | International Conference of |
| detergent | according to | Harmonization, resistant to |
| resistance | ICH Q1 | conventional detergent systems |

If possible, the coating should leave the grip and the sensation of grip uninfluenced on grasping the container, or improve it. In the case where it is not to be noticed haptically with the container that this has been provided with the coating, attention can simultaneously be drawn to the marking on the safety properties of the container by attachment of an appropriate comment. Advantage: in the case of a coating the handling does not change.

The thickness of the coating can vary depending on the shape and the material of the container, the type and amount of the components of the medium to be applied, and the decontamination and/or fracture strength and shatterproof strength to be achieved. The thickness can be, for example, 50-150 μm.

The wall strength of the container can be reduced as a result of the coating with the retention of the original fracture strength. By this means, the weight of the coated container can be reduced compared with the uncoated container. Preferably, an increase in the fracture strength is desired and achieved by retention of the wall strength.

The medium to be applied should fulfill individual criteria or all of the following criteria: Non- or only poorly flammable, odorless, cause no skin reactions (“not irritate the skin”), free of organic solvents (“solvent-free”), not systemically toxic on skin contact, ageing-resistant.

Furthermore, the outside of the coating should have no or almost no adhesive properties under the worldwide customary local temperature conditions (from tropical heat to Antarctic cold), since this could adversely affect the handleability. This can be carried out by means of a drying step (that is supply of heat) or a separate curing procedure controlled by UV light, which is carried out with dehumidified air instead of or additionally to the drying step.

For curing by supply of heat, a coating having thermosetting properties is convenient. For a coating having thermoplastic properties, the addition of separate curing components or the application of a separate second coating having thermosetting properties is advantageous.

The following exemplary embodiments are intended to illustrate the invention without restricting the latter thereto.

### EXEMPLARY EMBODIMENT 1

The starting point for the lacquering are the separate vials coming from the labeling. Depending on the amount of active compound to be filled, the size of the vials is alternatively 20 H, 30 H, 50 H, 75 H and 100 H (according to DIN 58366; in each case filled with 50 mg (vials size 20 H or 30 H according to DIN 58366), 1 g (vial size 50 H or 75 H according to DIN 58366) and 2 g (vial size 100 H according to DIN 58366) of sterile crystalline cyclophosphamide. The kind of glass of the vials is alternatively glass I or III. A chain conveyor picks up the vials on the bottle head (pickup can, for example, take place a.) pneumatically by means of suction apparatus or gripping devices or b.) mechanically by means of clamping or mechanically controlled gripping devices) and transports them to a spray booth, where they are coated in an “omega loop”. As mechanical protection against overspray, the vials pass through a labyrinth before and after the spray booth. In the spray booth, the vials encircle the lacquering unit almost completely. The path which is covered here corresponds to the shape of the Greek letter omega (Ω). Therefore the term omega loop also originates. The chain conveyor will be protected from the lacquer, for example by means of a masking.

The lacquer application is carried out by means of a rotating disk, a “disk atomizer”. The lacquer emerges on the bottom in the center and migrates outwards due to the flow forces. At the edge of the disk, the lacquer is atomized and continues to flow largely horizontally. The viscosity of the lacquer must be chosen such that the lacquer does not dry either in the lines or on the disk. On entry of the vials into the omega loop, a rotating motion (rotation around the individual axis) begins additionally to the forward motion. By means of this process and by means of the oscillating motion of the disk, complete lacquering from the bottom up to the crimped cap is guaranteed. Using this process, the lacquer application can be carried out in a very controlled manner (sharp lacquer edge, low scattering). A further advantage of this method is the lacquer application, which can be readily controlled and builds up slowly (homogeneous, readily controllable lacquer layer). The lacquer film can be regulated both by means of the speed of rotation of the disk or by means of the adjustment of the amount of lacquer to be atomized per unit time and by means of the speed of passage through the omega loop. In the spray booth, underpressure prevails in order to prevent an escape of lacquer into the environment. By applying a high voltage to the lacquer and generating ground potential on the vial, the lacquer process is improved and overspray is reduced.

Speed: max. about 7000 bottles/h

Spacing: min. 30 mm between the bottle walls
81 mm between bottle pickups

Conveyor speed: 9.45 m/min

Ø alpha disk: about 150 mm (with integrated rinse function)

Speed of rotation 15 000-25 000 min⁻¹

Coating spacing: about 190 mm

Ø omega loop: about 572 mm

Workpiece—booth wall

spacing: about 300 mm

Air settling velocity: min. 0.3 m/sec. High voltage: 0-100 kV
0-500 μA

The following lacquer has proven suitable at a 4% strength dilution of the lacquer described below:

Hydro-Abziehlack 3995.10 from Hemmelwrath, Klingenberg, Germany. The main constituent of the lacquer system is a water-dilutable, solvent-free polyurethane dispersion. Additional lacquer constituents are additives which serve for defoaming, for Theological properties, and for adhesive strength. In the form supplied (undiluted), the solids content is 40%; it follows therefrom that the remaining 60% is water. 1.5% oleic acid acroside is the only component which is mentioned as a hazardous ingredient in the safety data. The lacquer has the following properties: flashpoint: 100° C. Viscosity: thixotropic flow behavior;
about 8 dPa•s after stirring

Density at 20° C. 1.09 g/m³

Water-miscible

Boiling point: 100° C.

Vapor pressure at 20° C.: 24 mbar

pH: 8.0-9.5

Viscosity at a 4% Strength Dilution With Water:

about 6 dPa•s (decipascal seconds) after stirring and thorough mixing

After the lacquering process, the rotating vials are transferred to a drier which operates using dehumidified air up to at most 25° C. The moisture content of the drying air is markedly reduced by freezing out water such that the water absorption capacity according to the Mollier diagram is increased. Drier variants are a drying tower (spiral conveyor route=spacesaving) or a drier which the vials pass through in snaking lines (better accessibility). The flow rate in the drier is chosen in such a way that optimum drying is guaranteed within a minimum time. Condensation of moisture in the drier can be avoided by suitable choice of the atmospheric humidity and the air flow rate.

After drying, delivery to the cardboard box packing unit takes place (point of intersection to conventional manufacture).

### Exemplary Embodiment 1a

As exemplary embodiment 1, with the difference that unlabeled vials are lacquered. Labeling is carried out after drying and before delivery to the cardboard box packing unit.

### Exemplary Embodiment 2

The starting point for the lacquering are the isolated vials coming from labeling, the lacquering of the vials alternatively taking place here by means of a spray gun. Depending on the amount of active compound to be filled, the size of the vials is alternatively 20 H, 30 H, 50 H, 75 H and 100 H according to DIN 58366; in each case filled with 50 mg (vials size 20 H or 30 H according to DIN 58366), 1 g (vial size 50 H or 75 H according to DIN 58366) and 2 g (vial size 100 H according to DIN 58366) of sterile crystalline cyclophosphamide. The type of glass of the vials is alternatively glass I or III.

The lacquer as set forth in exemplary embodiment 1 is used, it optionally being possible to adjust its viscosity in a manner appropriate to use in a spray gun. A spray booth at underpressure is also needed in this method (with labyrinth). The vials are rotated during the lacquering process. A rhythmical lacquering process in which the vials remain standing in front of the spray gun and are lacquered from the bottom up to the crimped cap by means of a lifting motion of the gun is possible. Alternatively to this, the spray gun can carry out a horizontal motion additionally to the vertical motion and accompanying the vials during passage through the booth (advantage: continuous production; disadvantage: larger booth). The atomization of the lacquer takes place pneumatically. The pressure and the shape of the nozzle should be chosen such that the nozzle cannot block, uniform product transport is guaranteed and a uniform lacquer layer thickness is made possible. In addition, the pressure should correspond to the requirements of the spray diagram. The lacquering process can be optimized by applying high voltage to the lacquer and by means of ground potential on the vial. More overspray results with this process. The peripheral demarcation of the application is less exact than that in exemplary embodiment 1. In the case of complicated shapes, the spray gun offers more flexibility in comparison to the disk.

After the lacquering process, the rotating vials are transferred to a drier which operates using dehumidified air up to at most 25° C. The moisture content of the drying air is markedly reduced by freezing out water such that the water absorption capacity according to the Mollier diagram is increased. Drier variants are a drying tower (spiral conveyor route=spacesaving) or a drier which the vials pass through in snaking lines (better accessibility). The flow rate in the drier is chosen in such a way that optimum drying is guaranteed within a minimum time. Condensation of moisture in the drier can be avoided by suitable choice of the atmospheric humidity and the air flow rate.

After drying, delivery to the cardboard box packing unit takes place (point of intersection to conventional manufacture).

### Exemplary Embodiment 2a

As exemplary embodiment 2, with the difference that unlabeled vials are lacquered. Labeling takes place after drying and before delivery to the cardboard box packing unit.

### Exemplary Embodiment 3

The starting point for the lacquering are the isolated vials coming from labeling, the coating taking place in an immersion bath. Depending on the amount of active compound to be filled, the size of the vials is alternatively 20 H, 30 H, 50 H, 75 H and 100 H according to DIN 58366; in each case filled with 50 mg (vials size 20 H or 30 H according to DIN 58366), 1 g (vial size 50 H or 75 H according to DIN 58366) and 2 g (vial size 100 H according to DIN 58366) of sterile crystalline cyclophosphamide. The kind of glass of the vials is alternatively glass I or III.

The lacquer as set forth in exemplary embodiment 1 is used, it optionally being possible to adjust its viscosity in a manner appropriate to use in an immersion bath. The vials picked up on the head pass through an immersion bath which is coordinated to the vial size to be processed. By means of rotation around the individual axis, complete wetting is achieved. After leaving the immersion bath, the vials rotate further in order to guarantee a uniform runoff of the excess amount of lacquer. In addition, the vials are set slightly at a slant during the draining period in order that the excess lacquer can run off better via the unequivocally lowest point thereby resulting.

In this method, the metering of the amount of lacquer is carried out by adjusting the viscosity. A different layer thickness distribution is achieved by means of the runoff of the lacquer (lowest point=greatest layer thickness).

After the lacquering process, the rotating vials are transferred to a drier, which operates using dehumidified air up to at most 25° C. The moisture content of the drying air is markedly reduced by freezing out water such that the water absorption capacity according to the Mollier diagram is increased. Drier variants are a drying tower (spiral conveyor route=spacesaving) or a drier which the vials pass through in snaking lines (better accessibility). The flow rate in the drier is chosen in such a way that optimum drying is guaranteed within a minimum time. Condensation of moisture in the drier can be avoided by suitable choice of the atmospheric humidity and the air flow rate.

After drying, delivery to the cardboard box packing unit takes place (point of intersection to conventional manufacture).

### Exemplary Embodiment 3a

As exemplary embodiment 3, with the difference that unlabeled vials are lacquered. Labeling takes place after drying and before delivery to the cardboard box packing unit.

Exemplary Embodiments 4-9

In an analogous embodiment to exemplary embodiments 1-3, 1a, 2a, 3a, instead of the lacquer mentioned in exemplary embodiments 1-3 and 1a, 2a, 3a the following lacquer can also be employed:

Celerol-Liquid film 362-72 0900 transparent white from Mankiewicz (Hamburg, Germany). The lacquer system consists of a water-dilutable polyester-polyurethane dispersion. Additional lacquer constituents are additives which serve for defoaming, for rheological properties, and for adhesive strength. The solids content is about 45%. The remainder is water.

Viscosity: thixotropic flow behavior

Density at 20° C. 1 g/m³

Water-miscible

Boiling point: 120° C.

Vapor pressure at 50° C.: 100 hPa

### Exemplary Embodiments 10-25

In an analogous embodiment to exemplary embodiments 1-9, 1a, 2a, 3a, instead of the ‘blown glass bottles’ according to DIN 58366 mentioned there, tube glass bottles according to DIN ISO 8362-1 can also be employed.

TABLE 1
Table 1a:
Investigations on the decontamination of the outer surface of the
glass safety container according to the invention: (i) before
washing, (ii) after washing = before coating and (iii) after
coating (=safety container according to the invention)
The vials of size 20H (=20 ml), 30H (=30 ml), 50H
(=50 ml), 75H (=75 ml) and 100H (=100 ml) (in each case
made of glass types I and III) are filled with an appropriate amount
of sterile crystalline cyclophosphamide (50 mg for vials 20H and
30H, 1 g for vials 50H and 75H and 2 g for vials 100H) and sealed
with a stopper and crimped cap. They are subsequently
washed with washing solution. They are then coated according to the
invention (as set forth in exemplary embodiments 1 and 4).

| | Degree of decontamination of the |
|---|---|
| | outer surface |
| | (total amount of active compound |
| Type of container | ifosfamide per vial) 1) |
| Conventional (uncoated) vials | >1 μg |
| before external washing | |
| Conventional (uncoated) vials | between 100 ng-1000 ng |
| after external washing | |
| Vials 20H, 30H, 50H, 75H, 100H | in each case not detectable |
| coated according to the invention | (no contamination) |
| (as set forth in exemplary | |
| embodiment 1) made of glass I | |
| Vials 20H, 30H, 50H, 75H, 100H | in each case not detectable |
| coated according to the invention | (no contamination) |
| (as set forth in exemplary | |
| embodiment 1) made of glass III | |
| Vials 20H, 3H, 50H, 75H, 100H | in each case not detectable |
| coated according to the invention | (no contamination) |
| (as set forth in exemplary | |
| embodiment 4) made of glass I | |
| Vials 20H, 30H, 50H, 75H, 100H | in each case not detectable |
| coated according to the invention | (no contamination) |
| (as set forth in exemplary | |
| embodiment 4) made of glass III | |

Table 1b:
Investigations on the decontamination of the outer surface of the
plastic safety container according to the invention: (i) before
washing, (ii) after washing = before coating and (iii) after
coating (=safety container according to the invention)
The vials of size 20H, 30H, 50H, 75H and 100H (in each case
made of plastic) are filled with an appropriate amount of sterile
crystalline cyclophosphamide (50 mg for vials 20H and 30H,
1 g for vials 50H and 75H and 2 g for vials 100H) and sealed
with a stopper and crimped cap. They are subsequently washed with
washing solution. They are then coated according to the invention
(as set forth in exemplary embodiments 1 and 4).

| | Degree of contamination of the |
|---|---|
| | outer surface |
| | (total amount of active compound |
| Type of container | ifosfamide per vial) 1) |
| Conventional (uncoated) vials | >1 μg |
| before external washing | |
| Conventional (uncoated) vials | Between 100 ng-1000 ng |
| after external washing | |
| Vials 20H, 30H, 50H, 75H and | In each case not detectable |
| 100H coated according to the | (no contamination) |
| invention (according to exemplary | |
| embodiment 1) of plastic | |
| Vials 20H, 30H, 50H, 75H and | In each case not detectable |
| 100H coated according to the | (no contamination) |
| invention (according to exemplary | |
| embodiment 4) of plastic | |

1) Analytical method for residue determination: GC-MS; detection limit 10 ng

TABLE 2
Comparison tests on the fracture strength of conventional
containers (without coating) and the container according to the invention
(with coating).
Fracture strength: - Fall study using 10 coated and uncoated vials in each
case of sizes 20H, 30H, 50H, 75H and 100H of glass types I and III (in
each case with stoppers and fitted with a crimped cap, but not filled for
safety reasons) (free fall from about 1.5 m height onto stony ground). The
coating according to the invention was carried out according to exemplary
embodiments 1 and 4.

| | Result of the fall test for the |
|---|---|
| Type of container | fracture strength |
| Conventional (uncoated) vials | Fracture defects (1) occur |
| | in 100% of the vials |
| Vials of sizes 20H, 30H, 50H, 75H, | In each case no defects |
| 100H coated according to the | occur |
| invention (coating according to | |
| exemplary embodiment 1), glass | |
| type I | |
| Vials of sizes 20H, 30H, 50H, 75H, | In each case no defects |
| 100H coated according to the | occur |
| invention (coating according to | |
| exemplary embodiment 1), glass | |
| type III | |
| Vials of sizes 20H, 30H, 50H, 75H, | In each case no defects |
| 100H coated according to the | occur |
| invention (coating according to | |
| exemplary embodiment 4), glass | |
| type I | |
| Vials of sizes 20H, 30H, 50H, 75H, | In each case no defects |
| 100H coated according to the | occur |
| invention (coating according to | |
| exemplary embodiment 4), glass | |
| type III | |

(1) Fracture defects means: broken vials, whereby an uncontrolled release of the vial contents into the environment could occur

TABLE 3
Comparison tests on the shatterproof strength of conventional
containers (without coating) and containers according to the
invention (with coating).
Shatterproof strength: - Fall study using the the coated and uncoated
vials Free fall from about 2 m height onto stony ground. Fall study
using 10 coated and uncoated vials of sizes 20H, 30H, 50H, 75H
and 100H in each case of glass types I and III (in each case with stoppers
and fitted with a crimped cap, but not filled for safety reasons) (free fall
from about 1.5 m height onto stony ground). The coating according
to the invention was carried out according to exemplary
embodiments 1 and 4.

| | Result of the fall test for the |
|---|---|
| Type of container | shatterproof strength |
| Conventional (uncoated) vials made | Complete destruction of the |
| of glass | glass body (1) occurs in |
| | 100% of the vials |
| Vials in each case of sizes 20H, | Glass breakage with some |
| 30H, 50H, 75H, 100H coated | of the vials, but 100% of the |
| according to the invention, glass | vials have an intact polymer |
| type I (coating according to | coating (1) |
| exemplary embodiment 1) | |
| Vials in each case of sizes 20H, | Glass breakage with some |
| 30H, 50H, 75H, 100H coated | of the vials, but 100% of the |
| according to the invention, glass | vials have an intact polymer |
| type III (coating according to | coating (1) |
| exemplary embodiment 1) | |
| Vials in each case of sizes 20H, | Glass breakage with some |
| 30H, 50H, 75H, 100H coated | of the vials, but 100% of the |
| according to the invention, glass | vials have an intact polymer |
| type I (coating according to | coating (1) |
| exemplary embodiment 4) | |
| Vials in each case of sizes 20H, | Glass breakage with some |
| 30H, 50H, 75H, 100H coated | of the vials, but 100% of the |
| according to the invention, glass | vials have an intact polymer |
| type III (coating according to | coating (1) |
| exemplary embodiment 4) | |

(1) intact polymer coating: uncontrolled release of the vial contents into the environment cannot occur

Explanations of the Figures:

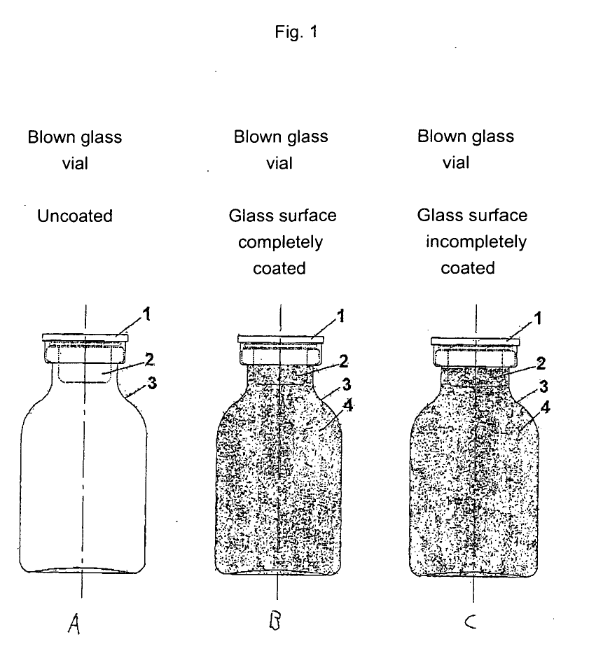

FIG. 1: Blown glass bottle (3) sealed with a rubber stopper (2) and flip-off crimped cap (e.g. of aluminum with a plastic cap) (1): uncoated (A); with the exception of the crimped cap (1) having a coating (4) (=partially coated) (B); with the exception of the crimped cap (1) having a coating (4), where in the area of the neck of the blown glass bottle in the vicinity of the crimped cap (1), the coating (4) gradually decreases (C).

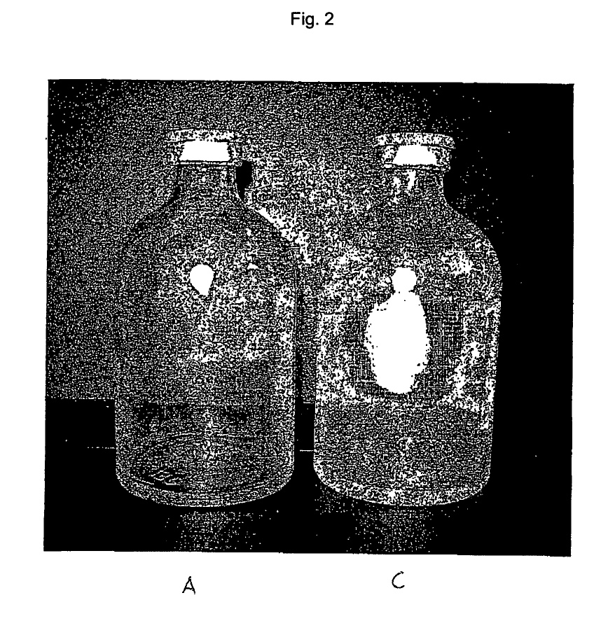

FIG. 2: Uncoated (A) and partially coated (=crimped cap uncoated) (C) blown glass bottles 100 H according to DIN 58366.

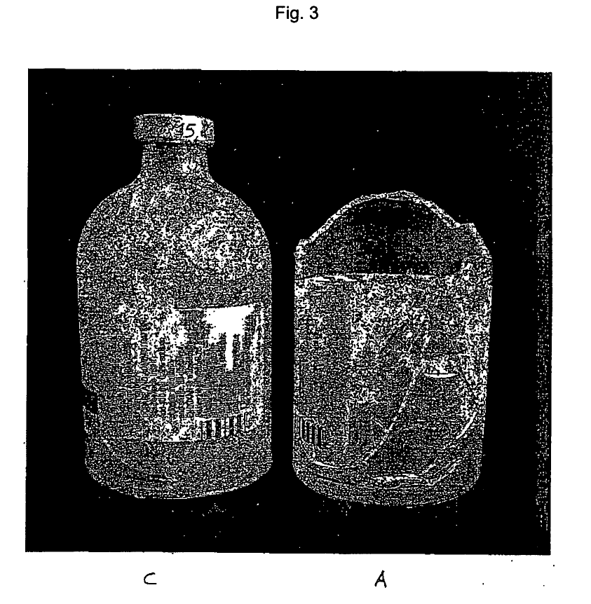

FIG. 3: Result of the fall test for the fracture strength and the shatterproof strength with the uncoated (A) and partially coated (=crimped cap uncoated) (C) blown glass bottle 100 H according to DIN 58366.

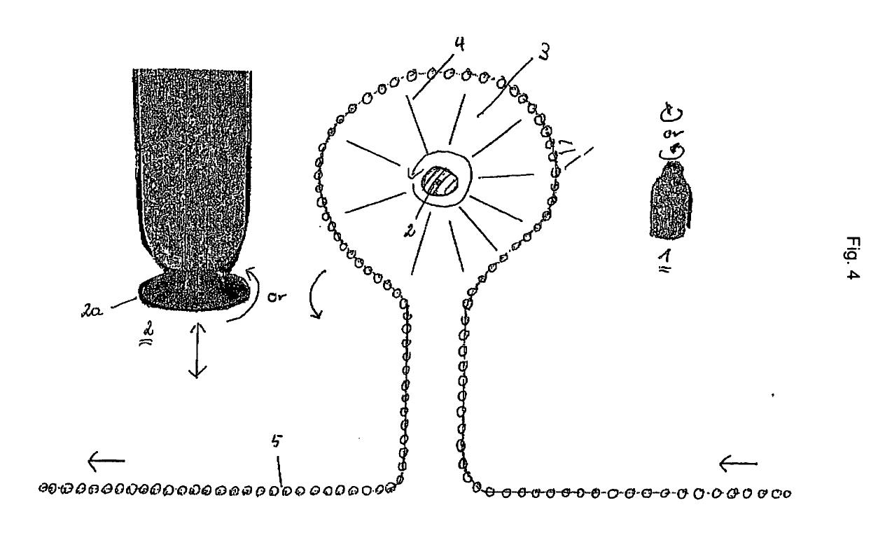

FIG. 4: Schematic representation of a view from above onto the “omega loop” (3) with an additional side view of the disk atomizer (spray disk) (2) and of a container (1): The containers (1), optionally in each case rotating around their own axis alternatively clockwise (→) or counterclockwise (←), run on a belt (5) around the spray disk (2) alternatively clockwise (→) or counterclockwise (←), the polymer-containing medium being fed centrally to the rotating disk (2a) and leaving the disk (2a) centrifugally and thereby a star-shaped spray area (4) lying mainly in one plane resulting. By raising and lowering ( [symbol] ) the spray disk (2), the plane of the spray area (4) can be changed as a function of the size and height of the container (1).

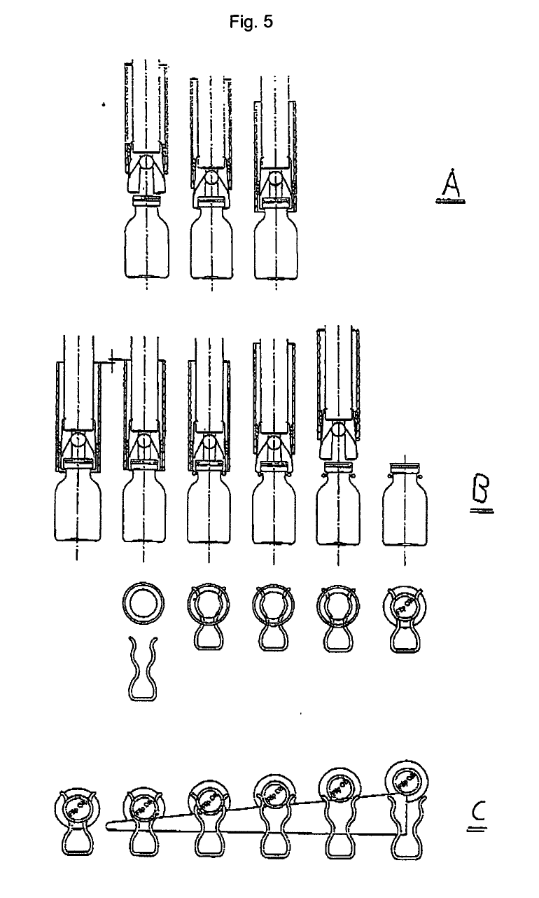

FIG. 5:

A: Picking up of the container after labelling:

A gripping device, which is constructed according to the principle of the propelling pencil, picks the container out of the star. The mechanics of the gripper are preferably to be protected from overspray.

B: Picking up of the container after coating:

The gripping device prints the container in an arc of round spring steel and then releases it.

C: Stripping off the container after drying.

1-56. (canceled)

57. A process for the production of filled and sealed safety containers for biologically active substances having high fracture strength and shatterproof strength, and a contamination-free outer surface, the container comprising a hollow body having at least one opening, one closure each per opening, at least one biologically active substance filled into the hollow body, and a coating having been applied at least partially to the outside of the filled and sealed container, comprising the steps of i) treating the filled and sealed container with a medium which contains at least one polymer, and ii) drying the container treated with the medium.

58. The process as set forth in claim 57, wherein the treatment in step i) is carried out by spraying.

59. The process as set forth in claim 58 wherein the spraying is carried out by the use of at least one of shear forces and flow forces.

60. The process as set forth in claim 59, wherein the shear forces are applied using a nozzle and the flow forces are applied using a rotating disk.

61. The process as set forth in claim 57, wherein the treatment is carried out by immersion.

62. The process as set forth in claim 57, wherein said step of treating the container is carried out by application of a powder.

63. The process as set forth in claim 57 further comprising providing the safety container with a label before the application of the coating.

64. The process as set forth in claim 57 further comprising before treating the filled and sealed container, treating the container with a wash medium.

65. The process as set forth in claim 57, wherein said step of treating the container is carried out at approximately room temperature.

66. The process as set forth in claim 57, wherein said step of drying is carried out at approximately room temperature.

67. The process as set forth in claim 57, wherein the coating is applied to substantially the entire container.

68. The process as set forth in claim 57, wherein the container is manufactured from one of glass and plastic.

69. The process as set forth in claim 57, wherein at least one closure comprises a rubber stopper and a crimped cap.

70. The process as set forth in claim 57, wherein the biologically active substance comprises a cytotoxic substance.

71. The process as set forth in claim 57, wherein the cytotoxic substance has been selected from the group consisting of ifosfamide, cyclophosphamide, trofosfamide, mafosfamide, S303, mitoxantrone, LHRH antagonists and glufosfamide.

72. The process as set forth in claim 57, wherein at least one polymer that is contained in the medium has been selected from the group consisting of polyurethane, polyester and polyesterpolyurethane mixtures.

73. A filled and sealed safety container for biologically active substances having a high fracture strength and shatterproof strength and a contamination-free outer surface, the container comprising a hollow body having at least one opening, one closure each per opening, at least one biologically active substance filled into the hollow body, and a coating applied to the filled and sealed container.

74. The safety container as set forth in claim 73, wherein the coating has been applied to substantially the entirety of the container.

75. The safety container as set forth in claim 73, wherein the container is manufactured from one of glass and plastic.

76. The safety container as set forth in claim 73, wherein said at least one closure comprises a rubber stopper and a crimped cap.

77. The safety container as set forth in claim 73, wherein the biologically active substance comprises a cytotoxic substance.

78. The safety container as set forth in claim 73, wherein the cytotoxic substance has been selected from the group consisting of ifosfamide, cyclophosphamide, trofosfamide, mafosfamide, S303, mitoxantrone, LHRH antagonists and glufosfamide.

79. The safety container as set forth in claim 73, wherein the container is treated with a medium containing at least one polymer.

80. The safety container as set forth in claim 79 wherein the at least one polymer is selected from the group consisting of polyurethane, polyester and polyester-polyurethane mixtures.

81. The safety container as set forth in claim 73, wherein the container is made of glass and the coating applied to the safety container contains at least one polymer selected from the group consisting of polyurethane, polyester and polyester-polyurethane mixtures.
